(19) United States
(12) Patent Application Publication
(10) Pub. No.: US 2025/0389580 A1
(43) Pub. Date: Dec. 25, 2025

(54) 3D PRINTED MULTI-MATERIAL OPTICAL FIBER SENSOR FOR SIMULTANEOUS DETECTION OF ULTRAVIOLET RADIATION AND TEMPERATURE

(71) Applicant: Khalifa University of Science and Technology, Abu Dhabi (AE)

(72) Inventors: Haider Butt, Abu Dhabi (AE); Dileep Chekkaramkodi, Abu Dhabi (AE)

(21) Appl. No.: 18/753,441

(22) Filed: Jun. 25, 2024

(51) Int. Cl. G01J 1/04; G01J 1/42; G01K 11/32

(52) U.S. Cl. CPC G01J 1/0425; G01J 1/429; G01K 11/32

(57) ABSTRACT

Techniques for producing an optical fiber sensor and for monitoring ultraviolet (UV) light and temperature using the optical fiber sensor are described. The optical fiber sensor can include a temperature-sensitive resin and a UV-sensitive resin. The temperature-sensitive resin can include a thermochromic powder and a polymer resin. The UV-sensitive resin can include a UV-sensitive powder and the polymer resin. Additionally, a data acquisition system can be electrically coupled to the optical fiber sensor for detecting an output signal from the optical fiber sensor and for determining a temperature or a level of UV light based on the output signal.

### BACKGROUND OF THE INVENTION

Ultraviolet (UV) light and temperature can be monitored in various sensing applications such as in biological, textile, petrochemical, and smart sensing applications. It may be useful to monitor UV light and temperature in a system or environment because significant changes to or differences in UV light and temperature can have adverse effects on the system or environment. For example, a significant change or difference in temperature and UV light can cause harm to biological cells, changes in chemical processes, color variations in textiles, or changes in material solubility. In current systems, UV light sensors and temperature sensors are often electrical. However, an accuracy of electrical UV light sensors and electrical temperature sensors can be hindered by climatic conditions. For example, an electrical UV light sensor or an electrical temperature sensor may generate incorrect readings due to electromagnetic interferences. Accordingly, a need exists for an accurate sensor that can be used in a variety of climatic conditions.

### BRIEF SUMMARY OF THE INVENTION

Embodiments of the present disclosure include a temperature and ultraviolet (UV) light detection system that includes an optical fiber sensor. The optical fiber sensor can include a temperature-sensitive resin, which can include a thermochromic powder and a polymer resin. The optical fiber sensor may also include a UV-sensitive resin, which can include a UV-sensitive powder and the polymer resin. The temperature and UV light detection system can further include data acquisition system electrically coupled to the optical fiber sensor. The data acquisition system can be configured to detect an output signal from the optical fiber sensor, which may correspond to an intensity of a light signal transmitted through the optical fiber sensor.

Another embodiment is directed to a method for using an optical fiber sensor to monitor UV light and temperature. The method can include providing the optical fiber sensor comprising a thermochromic powder, a UV-sensitive powder, and a polymer resin. The method can also include measuring, by a data acquisition system electrically coupled with the optical fiber sensor, a temperature and a level of UV light of an environment associated with the optical fiber sensor.

These illustrative examples are mentioned not to limit or define the disclosure, but to provide examples to aid understanding thereof. Additional embodiments and examples are discussed in the Detailed Description, and further description is provided there.

### BRIEF DESCRIPTION OF THE DRAWINGS

FIG. 1 shows a flowchart of an example of a method for producing an optical fiber sensor, according to some embodiments of the present disclosure.

FIG. 2A depicts examples of vertically oriented models of an optical fiber sensor, according to some embodiments of the present disclosure.

FIG. 2B shows examples of horizontally oriented models of an optical fiber sensor, according to some embodiments of the present disclosure.

FIGS. 3A shows cross-sectional Scanning Electron Microscope (SEM) images of a set of optical fiber sensors, according to some embodiments of the present disclosure.

FIGS. 3B shows cross-sectional Scanning Electron Microscope (SEM) images of a set of optical fiber sensors, according to some embodiments of the present disclosure.

FIG. 4A shows an example of a vertically printed multi-material optical fiber sensor, according to at least one embodiment of the present disclosure.

FIG. 4B shows an example of a horizontally printed multi-material optical fiber sensor, according to at least one embodiment of the present disclosure.

FIG. 4C shows an example of a mixed-material optical fiber sensor, according to at least one embodiment of the present disclosure.

FIG. 5A shows the vertically printed multi-material optical fiber at room temperature, according to at least one embodiment of the present disclosure.

FIG. 5B shows the horizontally printed multi-material optical fiber sensor at room temperature, according to at least one embodiment of the present disclosure.

FIG. 5C shows the mixed-material optical fiber sensor at room temperature, according to at least one embodiment of the present disclosure.

FIG. 6A shows the horizontally printed multi-material optical fiber sensor at forty-five degrees Celsius and under a UV light element, according to at least one embodiment of the present disclosure.

FIG. 6B shows the horizontally printed multi-material optical fiber sensor at forty-five degrees Celsius and under the UV light element, according to at least one embodiment of the present disclosure.

FIG. 6C shows the mixed-material optical fiber sensor at forty-five degrees Celsius and under a UV light, according to at least one embodiment of the present disclosure.

FIG. 7 shows a block diagram of an example of a temperature and ultraviolet (UV) light detection system including an optical fiber sensor, according to some embodiments of the present disclosure.

FIG. 8A shows plots of transmission spectra of a vertically printed multi-material optical fiber sensor, according to at least one embodiment of the present disclosure.

FIG. 8B shows plots of transmission spectra of a vertically printed multi-material fiber optic sensor, according to at least one embodiment of the present disclosure.

FIG. 8C shows plots of transmission spectra of a horizontally printed multi-material fiber, according to at least one embodiment of the present disclosure.

FIGS. 8D shows plots of transmission spectra of a horizontally printed mixed-material optical fiber sensor, according to at least one embodiment of the present disclosure.

FIG. 8E shows plots of transmission spectra of a vertically printed mixed-material optical fiber sensor, according to at least one embodiment of the present disclosure.

FIG. 9 shows a block diagram of an example of a temperature and UV light detection system including an optical fiber sensor, according to some embodiments of the present disclosure.

FIG. 10A shows plots of reflection spectra of a vertically printed multi-material optical fiber sensor, according to at least one embodiment of the present disclosure.

FIG. 10B shows plots of reflection spectra of a vertically printed multi-material fiber optic sensor, according to at least one embodiment of the present disclosure.

FIG. 10C shows plots of reflection spectra of a horizontally printed multi-material fiber, according to at least one embodiment of the present disclosure.

FIGS. 10D shows plots of reflection spectra of a horizontally printed mixed-material optical fiber sensor, according to at least one embodiment of the present disclosure.

FIG. 10E shows plots of reflection spectra of a vertically printed mixed-material optical fiber sensor, according to at least one embodiment of the present disclosure.

FIG. 11 shows a block diagram of an example of a temperature and UV light detection system including an optical fiber sensor, according to some embodiments of the present disclosure.

FIG. 12 shows a plot of power transmitted through different types of optical fiber sensors and under different conditions, according to at least one embodiment of the present disclosure.

FIG. 13 shows a flowchart of an example of a method for monitoring temperature and UV light using an optical fiber sensor, according to some embodiments of the present disclosure.

### DETAILED DESCRIPTION OF THE INVENTION

In the following description, various embodiments will be described. For purposes of explanation, specific configurations and details are set forth in order to provide a thorough understanding of the embodiments. However, it will also be apparent to one skilled in the art that the embodiments may be practiced in other configurations, or without the specific details. Furthermore, well-known features may be omitted or simplified in order not to obscure the embodiment being described.

Optical fiber sensors play an important role in sensing applications due to their precision, stability, adjustable functionality, and minimal signal degradation. Data can be transmitted as light waves from one end of an optical fiber sensor to another end of the optical fiber sensor with minimal attenuation. Optical fiber sensors can further be flexible, have sufficient strength for various applications, resist electromagnetic interference, and can be used for remote sensing applications. Thus, optical fiber sensors can detect diverse parameters, and can do so in challenging situations where conventional sensors may falter (e.g., in environments in which electromagnetic interferences may hinder electrical sensors).

Some aspects of the present disclosure relate to an optical fiber sensor for dual monitoring of Ultraviolet (UV) light and temperature. The optical fiber sensor can provide accurate and concurrent monitoring of UV light and temperature in various applications, including those in which electrical sensors may not be useful. The optical fiber sensor can be produced, at least in part, using digital light processing (DLP) 3D printing. Other techniques may also be used such as stereolithography (SLA) or fused filament fabrication (FFF). The optical fiber sensor can include a UV-sensitive powder (e.g., a photochromic powder) and a temperature-sensitive (e.g., a thermochromic powder), each of which may be combined with a hydrogel polymer to create one or more resins (e.g., a temperature-sensitive resin, a UV-sensitive resin, and a dual-sensitive resin). The resins may then be used in the DLP 3D printing of the optical fiber sensor.

Optical fibers of the optical fiber sensor can be horizontally oriented or vertically oriented based on a direction of printing using during the DLP 3D printing. The different orientations may provide different benefits. For example, horizontally oriented fibers can exhibit higher transmission than vertically oriented fibers, while vertically oriented fibers may exhibit higher reflectivity. High transmission can indicate that the optical fiber sensor can transmit data over long distances without significant attenuation. High reflectivity can indicate the optical fiber sensor can be used for remote monitoring applications. For example, high reflectivity can enable amplification of signals detected by the optical fiber sensor or localization of signals along the optical fiber sensor.

By measuring transmission percentage (e.g., a proportion of light traveling through the optical fiber sensor without being lost or absorbed), reflection percentage (e.g.., a proportion of light reflected by an interface of the optical fiber sensor), or a combination thereof with respect to the optical fiber sensor, a presence of UV radiation, of temperature fluctuations, or a combination thereof can be determined. The transmission percentage and the reflection percentage of the optical fiber sensor can be measured over various wavelengths to provide a transmission spectrum and a reflection spectrum respectively. Significant variation in the transmission spectrum or the reflection spectrum measured for the optical fiber sensor can make the optical fiber sensor ideal for dual sensing of UV light and temperature.

For example, there may be a change in the transmission percentage of the optical fiber sensor at 600 nanometers (nm) and at various temperatures (e.g., 25°C, 35°C, and 45°). There may further be an increased difference in transmission percentage at 600 nm upon exposure of the optical fiber sensor to UV radiation. Thus, a temperature of an environment associated with the optical fiber sensor and a level of UV light in the environment can be determined based on measuring the transmission percentage of the optical fiber sensor at 600 nm. In other examples, the transmission percentage at other or additional wavelengths may be used, or the reflection percentage at one or more wavelengths can be used to estimate temperature and UV light levels. Consequently, the presence of UV radiation and temperature fluctuations can be distinguished by analyzing changes in the transmission spectra, the reelection spectra, or the combination thereof of the optical fiber sensor. The proposed optical fiber sensors therefore provide a sensing platform for dual sensing applications where continuous monitoring of UV and temperature detection may be desired.

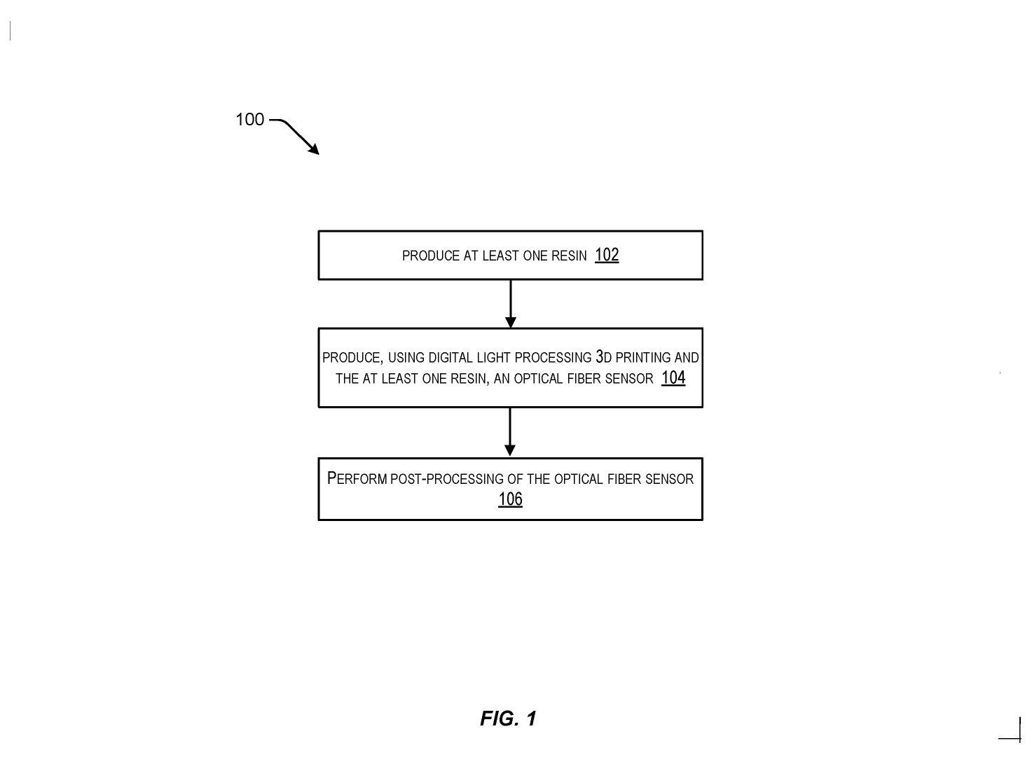

Turning now to the figures, FIG. 1 shows a flowchart of an example of a method 100 for producing an optical fiber sensor, according to some embodiments of the present disclosure. In other examples, the method 100 can include more steps, fewer steps, different steps, or a different order of the steps depicted in FIG. 1.

At block 102, the method 100 can involve producing at least one resin using an ultraviolet (UV)-sensitive powder, a thermochromic powder, and a polymer resin. The at least one resin can include a UV-sensitive resin, a temperature-sensitive resin, a dual-sensitive resin, or a combination thereof. In some examples, the polymer resin can include one or more photocurable polymers such as polyethylene glycol diacrylate (PEGDA, 98%), hydroxyethyl methacrylate (HEMA, 97%), other suitable polymers, or a combination thereof. The polymer resin may further include a photo-initiator (e.g., trimethybenzoyl diphenylphosphine oxide (TPO)). In other examples, other materials may be used in the polymer resin, or another type of resin may be used.

The thermochromic powder can be any suitable powder that is thermochromic (e.g., any suitable powder which changes color or transparency in response to temperature fluctuations). In other examples, the optical fiber sensor may include other temperature sensitive materials such as silica-based optical fibers, fiber Bragg gratings, or the like. The temperature sensitive materials can be any suitable material that exhibits changes in one or more optical properties in response to temperature fluctuations. Additionally, the UV-sensitive powder can be any suitable photochromic powder (e.g., any suitable powder which changes color or transparency when exposed to UV light). In other examples, the optical fiber sensor can include other UV-sensitive materials such as photosensitive coatings, silica optical fibers, or the like. The UV-sensitive materials can be any suitable material that exhibits changes in one or more of its optical properties in response to UV light exposure.

In one particular example, to produce the polymer resin, a 1:1 weight ratio of the PEGDA and the HEMA polymers can be used as well as 3 wt% TPO. The HEMA polymer can provide flexibility and biocompatibility to the optical fiber sensor, while PEGDA, a long-chain polymer, can help with HEMA cross-linking. The polymers may be mixed using a magnetic stirrer. For example, the polymers can be mixed at 500 revolution per minute (rpm) at room temperature for approximately 30 minutes.

Subsequently, in the particular example, 0.1% of the UV-powder can be introduced and stirred into the polymer resin for a period of time (e.g., approximately 15 minutes) to yield the UV-sensitive resin. Similarly, to produce the temperature-sensitive resin, 0.1% of the thermochromic powder can be introduced into the polymer resin and stirred for the period of time. Additionally in the particular example, the dual-sensitive resin can be prepared by adding 0.05% of the thermochromic powder and 0.05% of the UV-sensitive powder into the polymer resin and stirring. In other examples, different amounts of each powder, different ratios of polymers, other suitable materials, or a combination thereof may be used to produce the UV-sensitive resin, the temperature-sensitive resin, or the dual-sensitive resin.

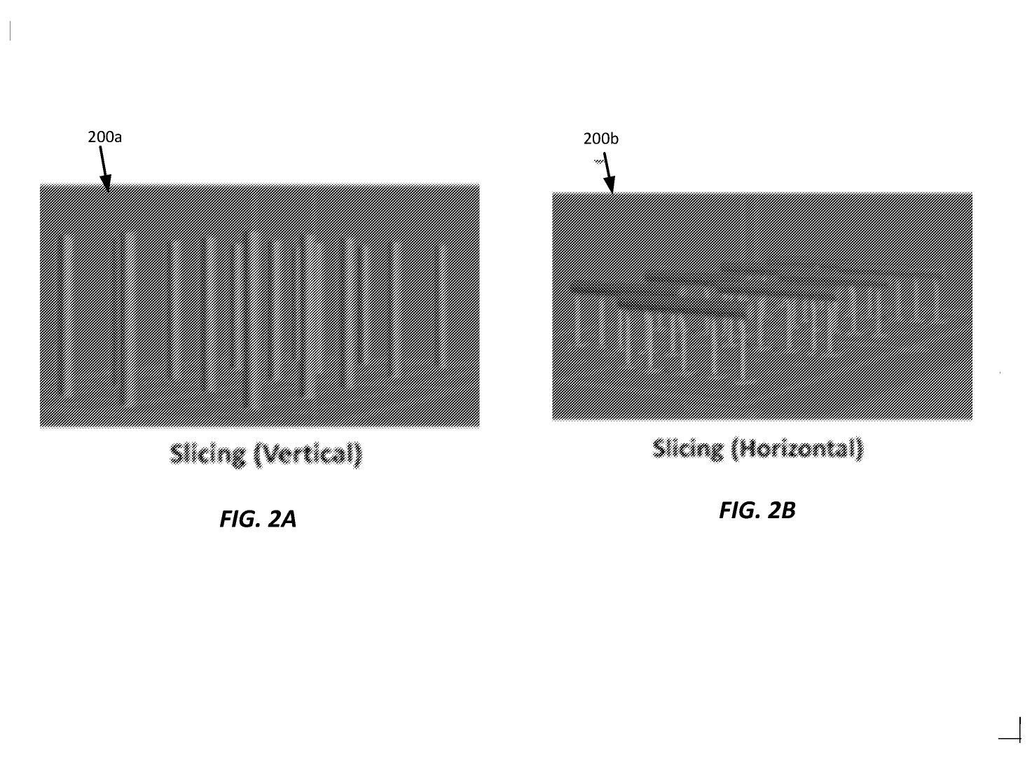

At block 104, the method 100 can involve producing, using digital light processing (DLP) 3D printing and the at least one resin, an optical fiber sensor. Prior to 3D printing the optical fiber sensor, models of the optical fiber sensor can be generated using a modeling software (e.g., Lychee slicer software). A first model can be oriented vertically, which may be parallel to a printing direction of a 3D printer used to perform the DLP 3D printing. A second model can be oriented horizontally, which may be perpendicular to the printing direction of the 3D printer. An example of vertically-oriented models 200a and of horizontally-oriented models 200b are shown in FIGS. 2A and 2B respectively.

In some examples, the dual-sensitive resin can be used to 3D print a mixed-material optical fiber sensor. In such examples, the 3D printing of the optical fiber sensor can be performed in one printing step and can be based on the first model or the second model. Thus, a mixed material optical fiber can have vertically oriented fibers or the mixed-material optical fiber can have horizontally oriented fibers.

In other examples, the temperature-sensitive resin and the UV-sensitive resin can be used to 3D print a multi-material optical fiber sensor. In such examples, the 3D printing of the optical fiber sensor can involve multiple printing steps. For example, a first step can involve 3D printing a first section of the optical fiber sensor with the temperature-sensitive resin and a second step can involve 3D printing a second section of the optical fiber sensor with the UV-sensitive resin. The multi-material optical fiber sensor can have any number of sections with the temperature-sensitive resin and any number of sections with the UV-sensitive resin. Additionally, the multi-material optical fiber sensor can be generated based on the first model or the second model, and can therefore have vertically oriented fibers or horizontally oriented fibers.

At block 106, the method 100 can involve performing post-processing of the optical fiber sensor. The post-processing of the optical fiber sensor can include UV curing for a period of time (e.g., 10 minutes), ultrasonic cleaning for a period of time, isopropanol cleaning for a period of time, other suitable post-processing treatments, or a combination thereof.

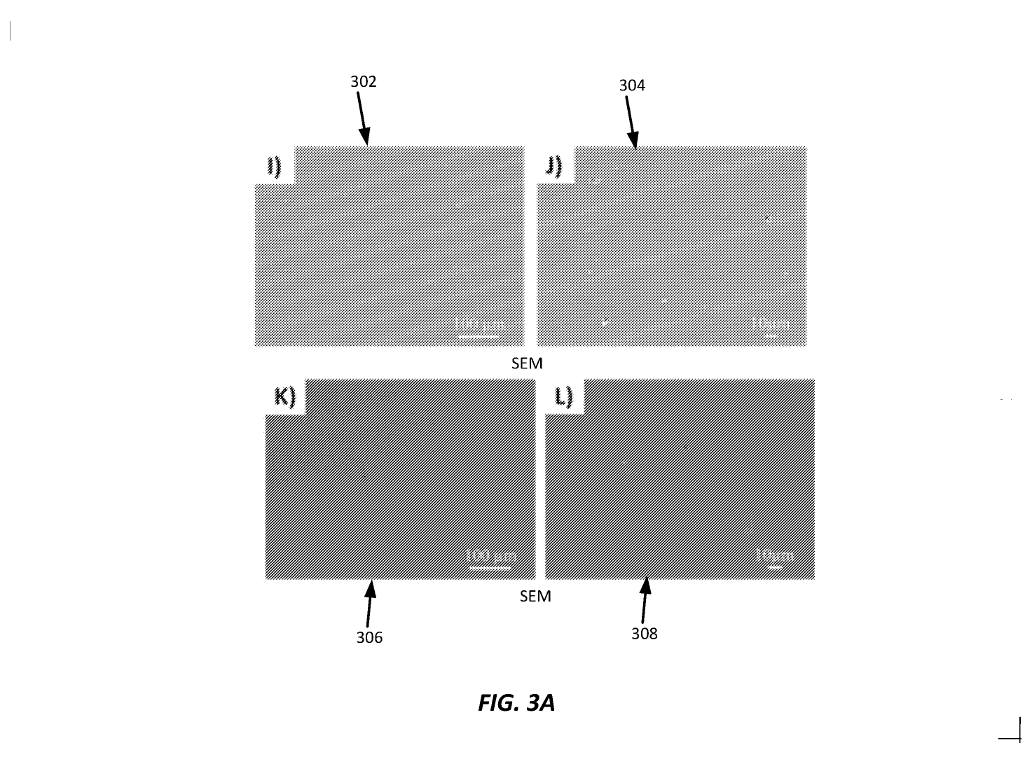

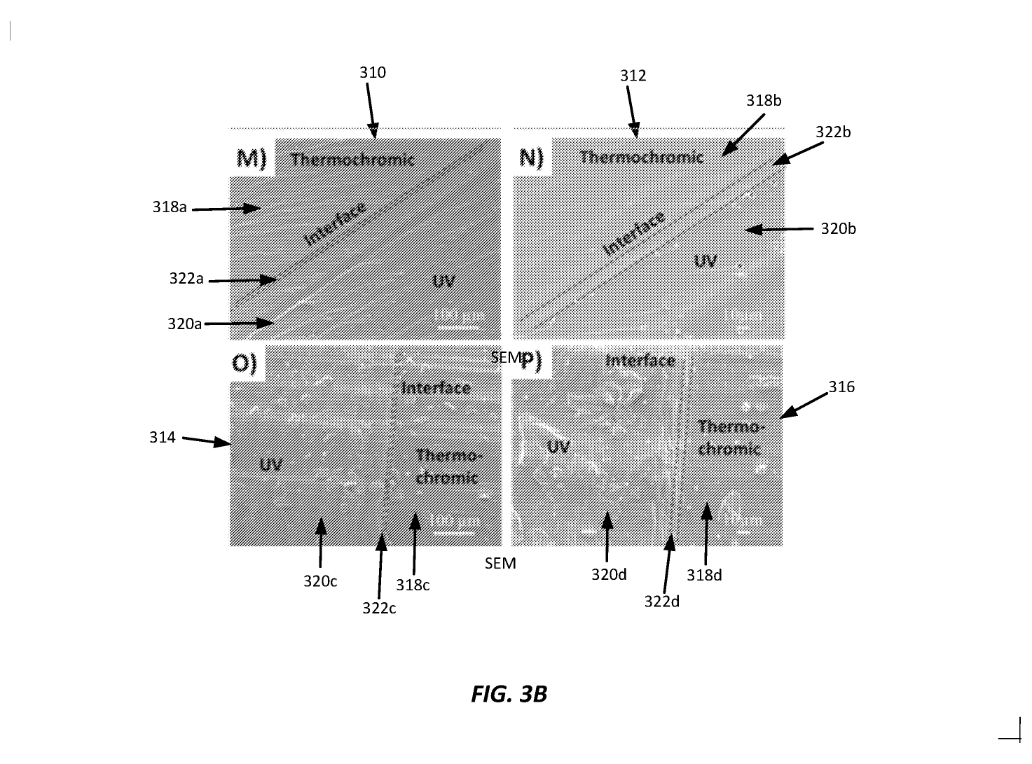

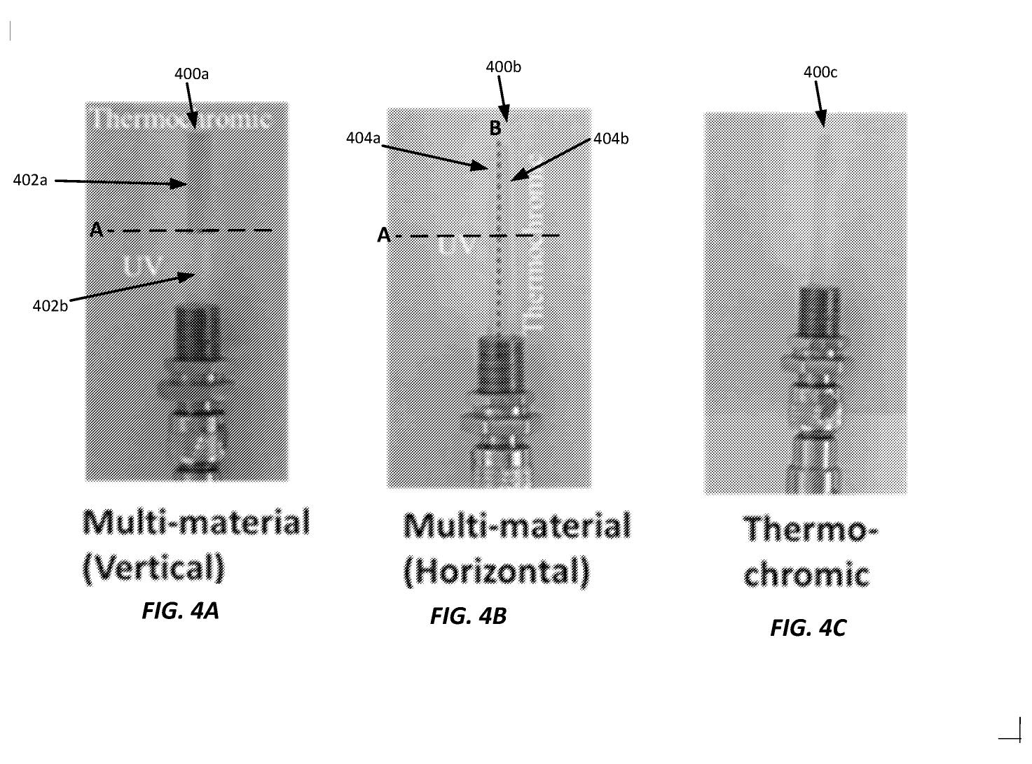

FIGS. 3A and 3B show cross-sectional Scanning Electron Microscope (SEM) images of a set of optical fiber sensors, according to some embodiments of the present disclosure. The cross-sectional SEM images can show how adding UV-sensitive powder, thermochromic powder, or a combination thereof to a polymer resin can affect a matrix of an optical fiber sensor made of the polymer resin. During SEM analysis, each of the optical fiber sensors can be mechanically fractured at a center. An example of where each optical fiber sensor may be fractured can be shown by plane A in FIG. 4. The cross-sections at which the optical fiber sensors were fractured may then be coated with a thin layer of gold or another suitable conductive material to enable SEM analysis and enable the cross-sectional SEM images to be taken.

In FIG. 3A, a first SEM image 302 and a second SEM image 304 can depict a mixed-material optical fiber with horizontally oriented fibers. Horizontally oriented fibers can be fibers which run perpendicular to plane A of FIG. 4. Additionally, a third SEM image 306 and a fourth SEM image 308 can depict a mixed-material optical fiber with vertically oriented fibers. Vertically oriented fibers can be fibers which run parallel to plane A of in FIG. 4.

In FIG. 3B, a fifth SEM image 310 and a sixth SEM image 312 can provide cross-sectional images of multi-material optical fiber sensors with horizontally oriented fibers, while a seventh SEM image 314 and an eighth SEM image 316 can show multi-material optical fiber sensors with horizontally oriented fibers. Each SEM image of a multi-material optical fiber sensor can show a thermochromic section 318a-d, which can be made of a temperature-sensitive resin, and a UV-sensitive section 320a-d, which can be made of a UV-sensitive resin. Each SEM image can further show an interface 322a-d at which each thermochromic section 318a-d and UV-sensitive section 320a-d meet. The interfaces 322a-d shown can result from using the temperature-sensitive resin in a first printing step and the UV-sensitive resin in another printing step when making the multi-material optical fiber sensors.

FIG. 4A shows an example of a vertically printed multi-material optical fiber sensor 400a. As shown, the optical fiber sensor 400a can have a first section 402a and a second section 402b. The first section 402a can be thermochromic due to the first section 402a being 3D printed with a temperature-sensitive resin (e.g., a resin comprising a thermochromic powder and a polymer resin). The second section 402b can be photochromic due to the second section 402b being 3D printed with a UV-sensitive resin (e.g., a resin comprising a photochromic powder and a polymer resin). Due to optical fiber being printed vertically (e.g., according to the models 200a shown in FIG. 2A), optical fibers of each of the sections 402a-b can run substantially parallel to a cross-section of the optical fiber sensor 400a shown along plane A. As a result, the sections 402a-b can span a width of the optical fiber sensor 400a and can span a portion of a length of the optical fiber sensor 400a. Plane A can further represent an interface between the sections 402a-b at which a material of the optical fiber sensor 400a changes from the temperature-sensitive resin to the UV-sensitive resin.

FIG. 4B shows an example of a horizontally printed multi-material optical fiber sensor 400b. As shown, the optical fiber sensor 400b can have a first section 404a and a second section 404b. The first section 404a can be photochromic due to the first section 404a being 3D printed with a UV-sensitive resin (e.g., a resin comprising a photochromic powder and a polymer resin). The second section 404b can be thermochromic due to the second section 404b being 3D printed with a temperature-sensitive resin (e.g., a resin comprising a thermochromic powder and a polymer resin). Due to optical fiber being printed horizontally (e.g., according to the models 200b shown in FIG. 2B), optical fibers of each of the sections 404a-b can be substantially perpendicular to a cross-section of the optical fiber sensor 400a shown along plane A. Instead, the optical fibers can run substantially parallel to Plane B. Plane B can further represent an interface between the sections 404a-b at which the material of the optical fiber sensor 400b changes from the temperature-sensitive resin to the UV-sensitive resin.

FIG. 4C shows an example of a mixed-material optical fiber sensor 400c. The optical fiber sensor 400c can be photochromic and thermochroic due to the optical fiber sensor 400c being made of a dual-sensitive resin (e.g., a resin comprising a photochromic powder, a thermochromic powder, and a polymer resin).

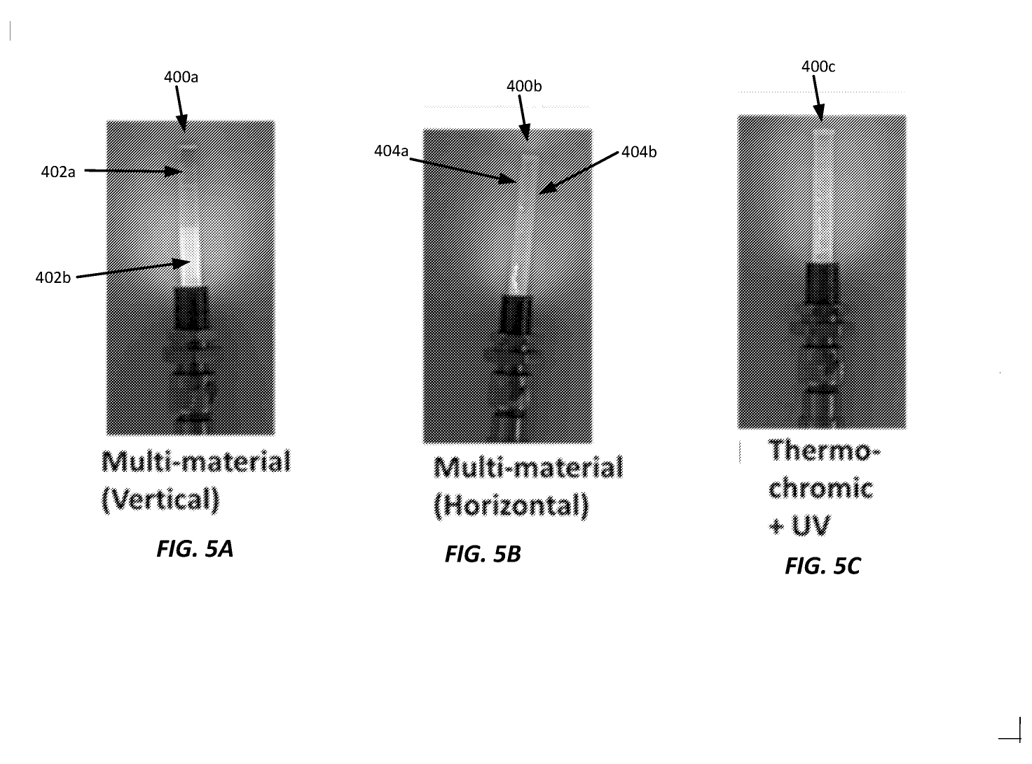

FIG. 5A shows the vertically printed multi-material optical fiber sensor 400a at room temperature. At room temperature, the first section 402a of the optical fiber sensor 400a can be illuminated and, more specifically, can appear red. In other examples in which other thermochromic materials may be used to generate the optical fiber sensor 400a, the first section 402a can have other suitable optical characteristics at room temperature (e.g., can appear colorless or another color). Additionally, there may be a low level of UV light in an environment of the optical fiber sensor 400a. Thus, the second section 402b of the optical fiber sensor 400a can be relatively colorless. In other examples in which other photochromic materials may be used to generate the optical fiber sensor 400a, the second section 402b can have other suitable optical characteristics at the low level of UV light (e.g., can appear blue, red, or another suitable color).

FIG. 5B shows the horizontally printed multi-material optical fiber sensor 400b at room temperature. Similar to the vertically printed multi-material optical fiber sensor 400a, at room temperature the second section 404b of the optical fiber sensor 400b can be illuminated and, more specifically, can appear red. Additionally, there may be a low level of UV light in an environment of the optical fiber sensor 400b. Thus, the second section 404b of the optical fiber sensor 400b can be relatively colorless.

FIG. 5C shows the mixed-material optical fiber sensor 400c at room temperature. Due to the optical fiber sensor 400c being both photochromic and thermochromic along its length, the optical fiber sensor 400c can be illuminated red. However, the red may appear fainter in comparison with the first section 402a of the optical sensor 400a and the second section 404b of the optical fiber sensor 400c. This can be due a low level of UV light in an environment of the optical fiber sensor 400c causing the photochromic particles of the photochromic powder in the optical fiber sensor 400c to be colorless.

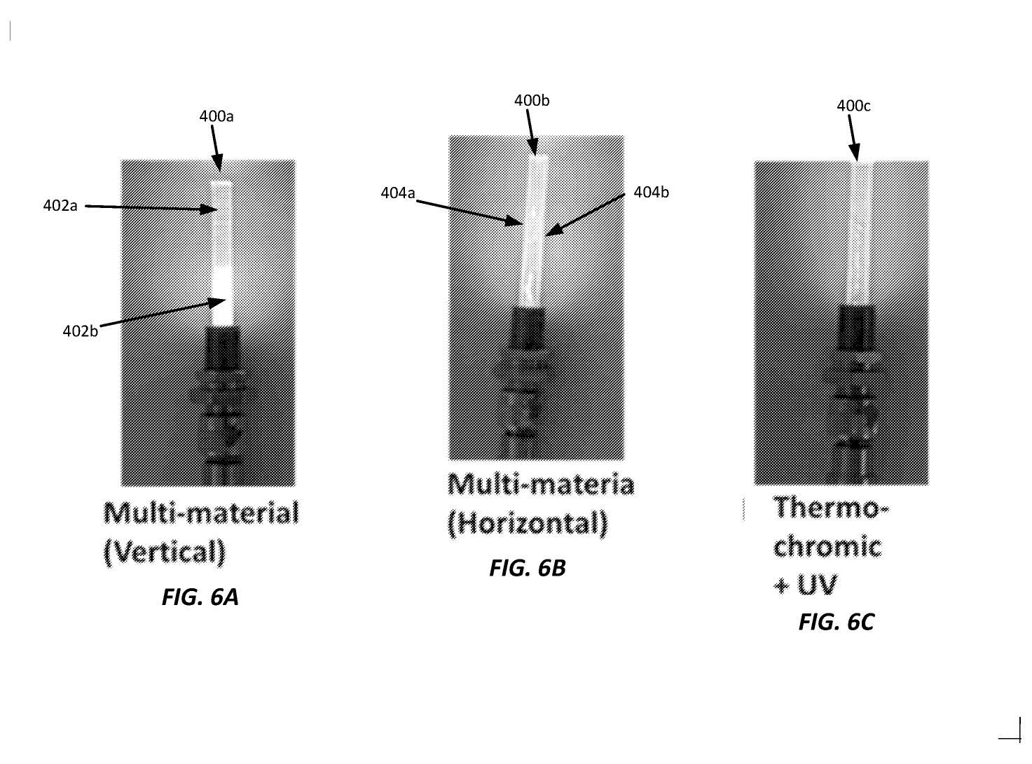

FIG. 6A shows the horizontally printed multi-material optical fiber sensor 400a at forty-five degrees Celsius and under a UV light element. The UV light element can expose the optical fiber sensor 400a to UV light of any wavelength (e.g., a wavelength between 100 and 200 nm, 200 and 300 nm, between 300 and 400 nm, etc.). Additionally or alternatively, the UV light element can expose the optical fiber sensor 400a to UV light of any level of intensity (e.g., approximately 5 Watts per square meter (W/m²). Thus, there may be a relatively high level of UV light in the environment of the optical fiber sensor 400a due to the optical fiber sensor 400a being under the UV light. Consequently, the second section 402b of the optical fiber sensor 400a can be illuminated. In some examples, the second section 402b (e.g., the photochromic section) can appear blue under the UV light. Additionally, the thermochromic powder used in the optical fiber sensor 400a can lose color with increasing temperatures and become colorless at temperatures equal to or greater than 45 degrees Celsius. Thus, as depicted, the first section 402a of the optical fiber sensor 400a can be colorless.

FIG. 6B shows the horizontally printed multi-material optical fiber sensor 400b at forty-five degrees Celsius and under the UV light element. Similar to the vertically printed multi-material optical fiber sensor 400a, the second section 404b (e.g., the thermochromic section) of the optical fiber sensor 400b can be colorless at 45 degrees Celsius. Additionally, there may be a relatively high level of UV light in the environment of the optical fiber sensor 400b due to the optical fiber sensor 400a being under the UV light. Thus, the first section 404a of the optical fiber sensor 400b can be illuminated. In some examples, the first section 404a (e.g., the photochromic section) can appear blue under UV light.

FIG. 6C shows the mixed-material optical fiber sensor 400c at forty-five degrees Celsius and under a UV light. Due to the optical fiber sensor 400c being both photochromic and thermochromic along its length, the optical fiber sensor 400c can be illuminated due to the UV light. However, the illumination may appear fainter in comparison with the second section 404b of the optical sensor 400a and the first section 404a of the optical fiber sensor 400c. This can be due to the environment of the optical fiber sensor 400c having a temperature of forty-five degrees Celsius, which can cause the photochromic particles in the optical fiber from the photochromic powder to be colorless.

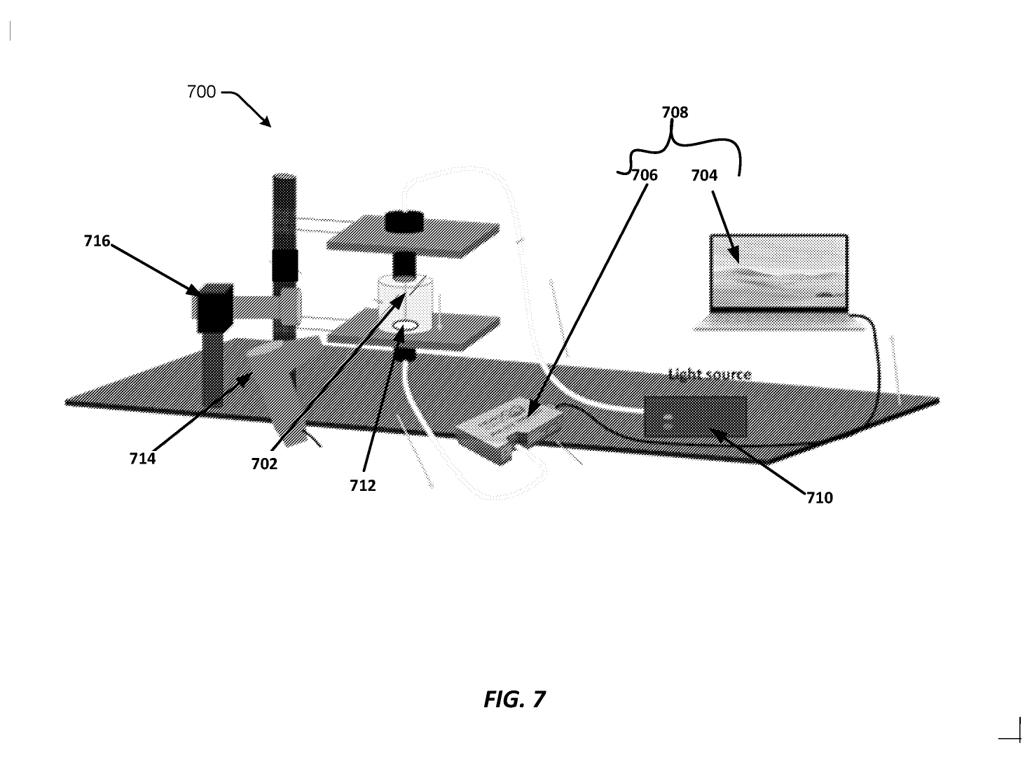

FIG. 7 shows a block diagram of an example of a temperature and ultraviolet (UV) light detection system 700 including an optical fiber sensor 702, according to some embodiments of the present disclosure. In addition to the optical fiber sensor 702, the system 700 can include a data acquisition system 708 electrically coupled with the optical fiber sensor 702. The data acquisition system 708 can include one or more components for receiving an output signal from the optical fiber sensor 702 and processing the output signal. For example, the data acquisition system 708 can include a spectrometer 706 or other suitable device for measuring an intensity of a light signal transmitted through the optical fiber sensor 702 and a computing device 704 for a receiving and processing the measured intensity.

In some examples, the system 700 can further include a light source 710 for transmitting a light signal to the optical fiber sensor 702. The light source 710 can include light emitting diodes (LEDs) or other suitable devices for emitting a light signal. The optical fiber sensor 702 can be a mixed-material optical fiber sensor or a multi-material optical fiber sensor and can have vertically oriented or horizontally oriented optical fibers. A collimating lens 712 or other suitable element may direct the light signal, after transmission through the optical fiber sensor 702, to the spectrometer 706 for measurement. The collimating lens 712 may therefore be positioned near an opposite side of the optical fiber sensor 702 from a side at which the light signal was received. The collimating lens 712 can enable the data acquisition system 708 to collect the transmitted light signal efficiently to improve an accuracy of the intensity measurement.

In some examples, the system 700 can also include a heating element 714 and a UV light element 716 for applying heat and UV light respectively to an environment associated with the optical fiber sensor 702. In other examples, temperature fluctuations or UV light exposure of the optical fiber sensor 702 can be naturally occurring (e.g., from climate changes, sun exposure, etc.) and therefore the system 700 may not include the heating element 714 and UV light element 716. As a result of temperature fluctuations, UV light exposure, or a combination thereof, one or more optical properties of the optical fiber sensor 702, which can include a thermochromic powder and a photochromic powder, can change. As a result, an intensity of the light signal transmitted through the optical fiber sensor 702 may change (e.g., more or less light may be transmitted depending on the new optical properties). Thus, by measuring the intensity of the light signal transmitted through the optical fiber sensor 702, the data acquisition system 708 can determine a temperature, a level of UV light exposure, or a combination thereof of the optical fiber sensor 702 and therefore of the environment associated with the optical fiber sensor 702.

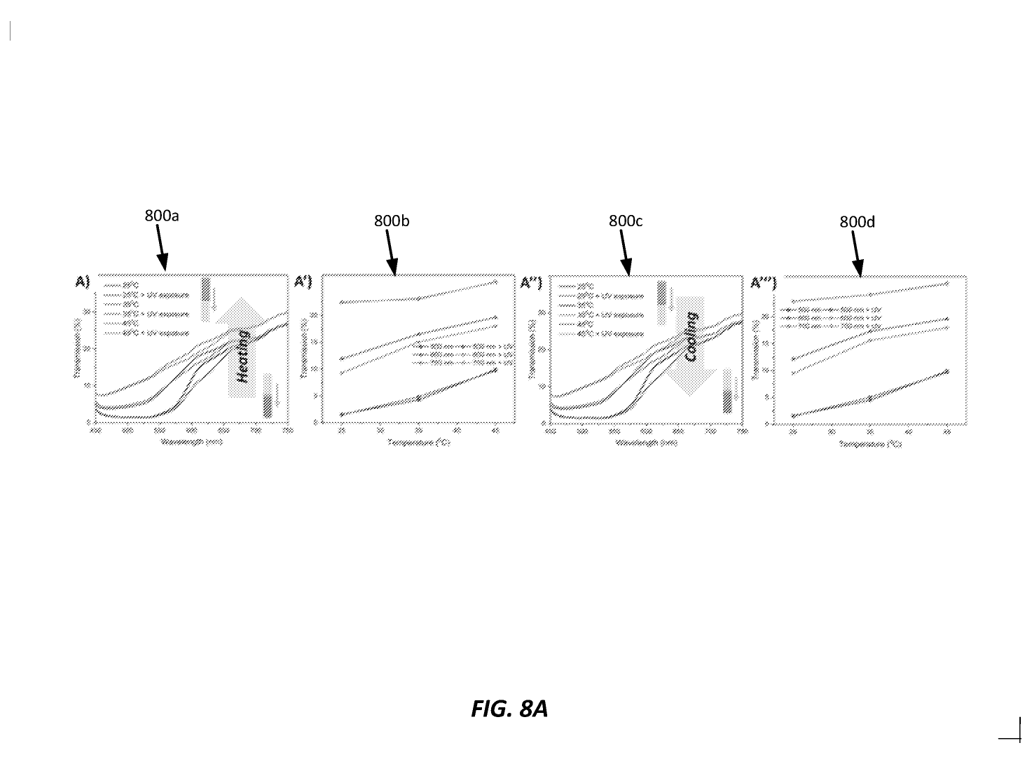

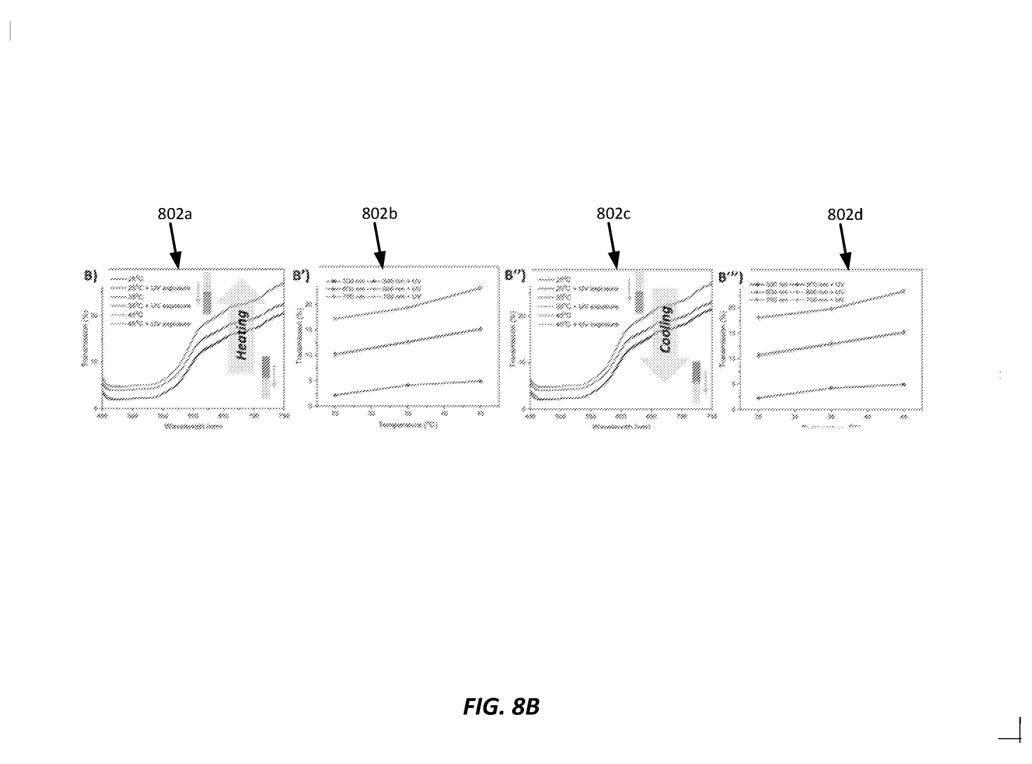

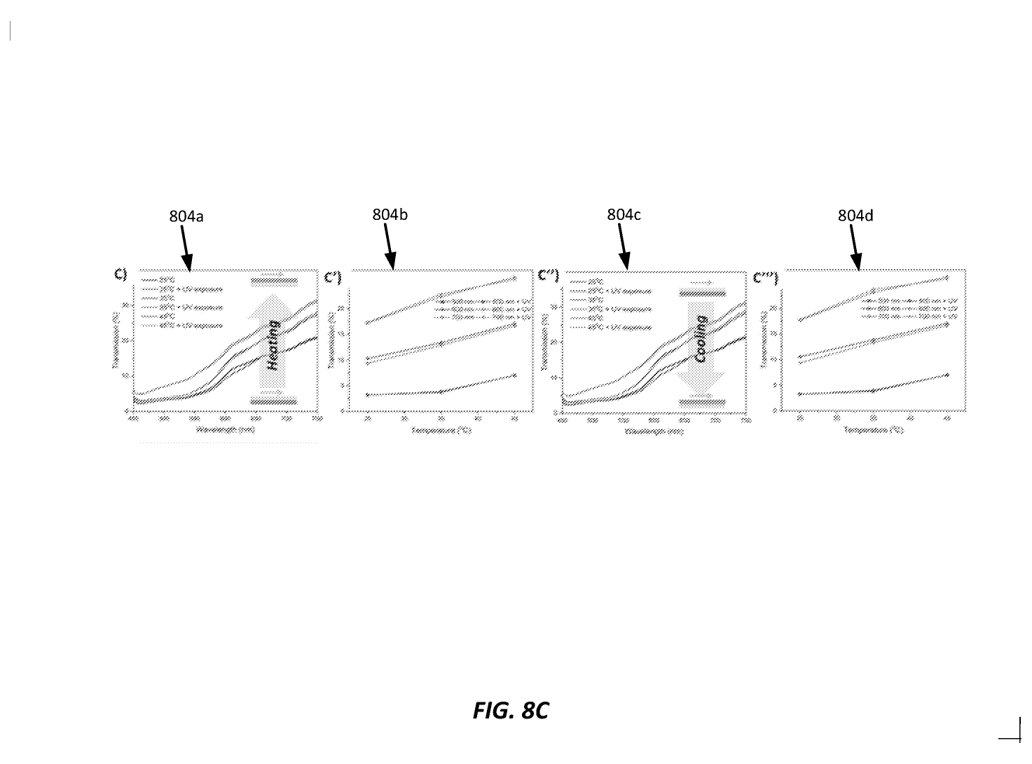

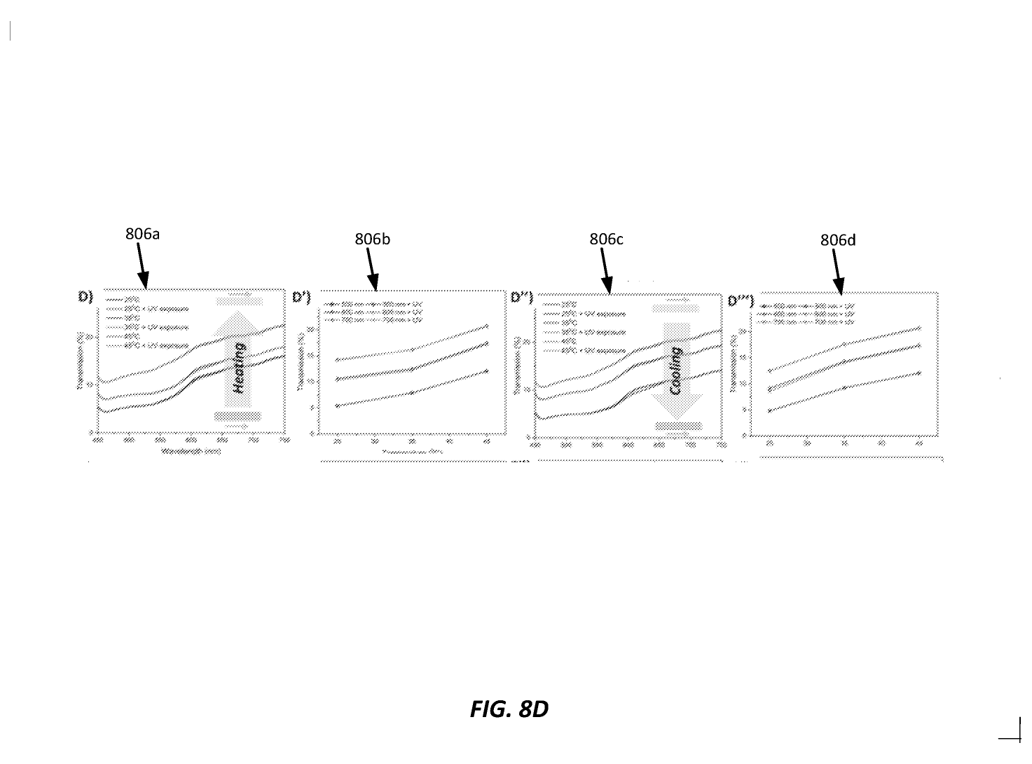

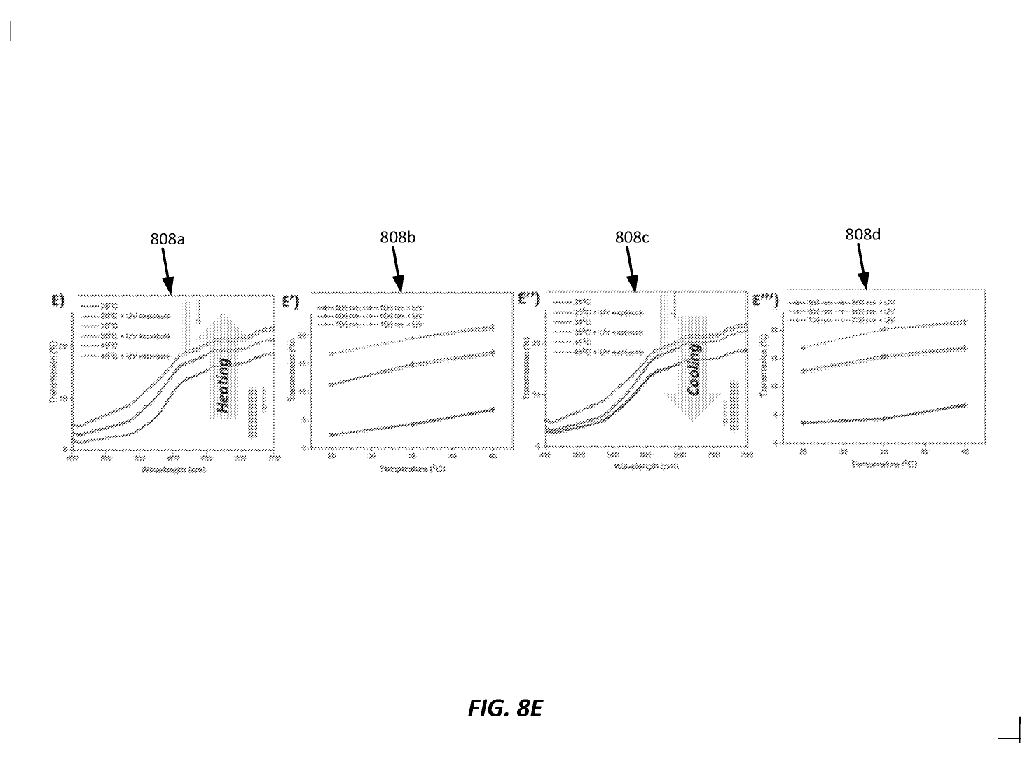

FIG. 8A shows plots 800a-d of transmission spectra of a vertically printed multi-material optical fiber sensor, according to at least one embodiment of the present disclosure. An example of a vertically printed multi-material optical fiber sensor 400a is depicted in FIGS. 4A, 5A, and 6A. The vertically printed multi-material optical fiber sensor can be positioned in a temperature and ultraviolet (UV) light detection system, such as the temperature and ultraviolet (UV) light detection system 700 depicted in FIG. 7. In a particular example, a UV-sensitive section (e.g., section 402b) of the optical fiber sensor can be positioned close to an incoming light signal (e.g., a light signal from light source 710) while a temperature-sensitive section (e.g., section 402a) can be located near a collimating lens (e.g., collimating lens 712). The transmission spectra can include transmission spectrums of the optical fiber sensor under various conditions. For example, the plots 800a-d can show a transmission spectrum of the optical sensor at 25 degrees Celsius without UV exposure, at 25 degrees Celsius with UV exposure, at 35 degrees Celsius without UV exposure, at 35 degrees Celsius with UV exposure, at 45 degrees Celsius without UV exposure, and at 45 degrees Celsius with UV exposure.

As shown in plots 800a-d, when the vertically printed multi-material optical fiber sensor is heated, there is an increase in the transmission spectra. Upon cooling, as shown in plot 800c, the transmission spectra of the optical fiber sensor are similar to the transmission spectra of the optical fiber sensor upon heating with slight hysteresis. Thus, variation in the transmission spectra can be reversible upon cooling the vertically printed multi-material optical fiber sensor.

Additionally, as shown in plots 800a and 800c, exposure to UV light can cause a dip in the transmission spectra within the 600 to 620 nm range. The dip in the 600 to 625 nm range appears at 25°C, 35°C, and 45°C respectively in plots 800a and 800c. For example, in plots 800a and 800c, the transmission percentage of light at 600 nm is approximately 12.13%, 17.31%, and 19.62% at 25°C, 35°C, and 45°C, respectively without exposure to UV light. Upon exposure to UV light, the transmission percentages decrease to approximately 9.5%, 15.6%, and 17.98% at 600 nm. Thus, in the particular example, the transmission percentage of the vertically printed multi-material optical fiber sensor varies with temperature changes. However, aside from the 600 nm range, the impact of UV exposure on the transmission percentage of the vertically printed multi-material optical fiber sensor is minimal. Consequently, in the particular example, the vertically printed multi-material optical fiber sensor can be used for sensing UV light and temperature by analyzing the transmission percentage around 600 nm.

FIG. 8B shows plots of transmission spectra of a vertically printed multi-material fiber optic sensor, according to at least one embodiment of the present disclosure. Similar to the previous example depicted in FIG. 8A, the vertically printed multi-material optical fiber sensor can be positioned in a temperature and ultraviolet (UV) light detection system, such as the temperature and ultraviolet (UV) light detection system 700 depicted in FIG. 7. In contrast to the previous example, a UV-sensitive segment of the vertically printed multi-material optical fiber sensor can be positioned near a collimating lens, while a temperature sensitive section can be located near an incoming light signal. Plots 802a-d can show transmission spectra of the vertically printed multi-material optical fiber sensor at 25 degrees Celsius without UV exposure, at 25 degrees Celsius with UV exposure, at 35 degrees Celsius without UV exposure, at 35 degrees Celsius with UV exposure, at 45 degrees Celsius without UV exposure, and at 45 degrees Celsius with UV exposure.

As shown in plots 802a-d, upon heating, the temperature spectra of the vertically printed multi-material optical fiber sensor can exhibit an upward shift. In contrast to the previous example, plots 802a-d show that the vertically printed multi-material optical fiber sensor’s response to UV light is minimal. This may be attributed to the positioning of the vertically printed multi-material optical fiber sensor. For example, due to the temperature-sensitive section of the optical fiber sensor being positioned closer to the light source, the temperature-sensitive section can filter the light signal prior to the light signal reaching the UV-sensitive section. Thus, the light signal can have a lower intensity upon entering the UV-sensitive section of the optical fiber sensor. Upon exposure to UV light, the UV-sensitive section may not significantly decrease the intensity of light signal as the light signal is pre-filtered by the temperature section. Consequently, the UV-sensitive section of the vertically printed multi-material optical fiber sensor can have a limited impact on the transmission spectra.

In particular, as shown in plots 802a-d, at a wavelength of 600 nm and without UV exposure, transmission percentages of the vertically printed multi-material optical fiber sensor are 10.29%, 12.73%, and 15.27% at temperatures of 25°C, 35°C, and 45°C, respectively. Under UV exposure, the transmission percentages decrease to 10.01%, 12.51%, and 15.01%. Therefore, a vertically printed multi-material optical fiber sensor positioned with a temperature sensitive section closer to an incoming light signal can be used to measure temperature and UV levels upon calibration. The calibration can be performed to enable detection of the small changes in transmission percentages upon exposure of the vertically printed multi-material optical fiber sensor to UV light.

FIG. 8C shows plots 804a-d of transmission spectra of a horizontally printed multi-material fiber, according to at least one embodiment of the present disclosure. An example of a horizontally printed multi-material optical fiber sensor 400b is depicted in FIGS. 4B, 5B, and 6B. The horizontally printed multi-material optical fiber sensor can be positioned in a temperature and ultraviolet (UV) light detection system, such as the temperature and ultraviolet (UV) light detection system 700 depicted in FIG. 7. Due to a UV-sensitive section (e.g., section 404a) and a temperature-sensitive section (e.g., section 404b) of the horizontally printed multi-material optical fiber sensor having horizontally oriented fibers, both sections can be positioned with a portion close to the light source and a portion close to a collimating lens. Similar to the previous examples, plots 804a-d can show transmission spectrums of the optical fiber sensor at 25 degrees Celsius without UV exposure, at 25 degrees Celsius with UV exposure, at 35 degrees Celsius without UV exposure, at 35 degrees Celsius with UV exposure, at 45 degrees Celsius without UV exposure, and at 45 degrees Celsius with UV exposure.

In this example, as shown in plots 804a-d, there is a notable change (e.g., an increase) in the transmission spectra of the horizontally printed multi-material optical fiber sensor corresponding to temperature variations (e.g., heating). Additionally, as shown in plots 804a-d, there is a lower impact of exposure to UV light on the transmission spectra. The increase in the transmission spectra during heating can be due the temperature-sensitive portion becoming colorless during heating. Without UV exposure, the UV-sensitive section may also be colorless, which enables the light signal to also travel through the UV sensitive section of with minimal disturbance. However, during UV exposure, the UV-sensitive half may absorb some light due to its transparent-to-blue color change. As a result, there can be a decrease in the transmission spectra during UV exposure.

As shown in plots 804a and 804c, at 600 nm, the transmission percentages of the horizontally printed multi-material optical fiber sensor are 10.25%, 13.37%, and 17.05% for temperatures of 25°C, 35°C, and 45°C, respectively. Additionally, as shown in plots 804a and 804c, under UV exposure, the transmission percentages decrease to 9.1%, 12.86%, and 16.62%. A slight variation between the transmission spectra for the optical fiber sensor with UV exposure and for the optical fiber sensor without UV exposure can also observed in plots 804a and 804c at approximately 700 nm. Consequently, in this example, the horizontally printed multi-material optical fiber sensor can be used for sensing UV light and temperature by analyzing the transmission percentage around 600 nm, around 700 nm, or a combination thereof.

FIGS. 8D shows plots 806a-d of transmission spectra of a horizontally printed mixed-material optical fiber sensor, while FIG. 8E shows plots 808a-d of transmission spectra of a vertically printed mixed-material optical fiber sensor. An example of a mixed-material optical fiber sensor 400c is depicted in FIG. 4C, FIG. 5C, and FIG. 6C. The horizontally printed and the vertically printed mixed-material optical fiber sensor can be positioned in a temperature and ultraviolet (UV) light detection system, such as the temperature and ultraviolet (UV) light detection system 700 depicted in FIG. 7.

As shown by plots 808a-d in comparison with plots 806a-d, the vertically printed mixed-material optical fiber sensor can exhibit lower transmission compared to the horizontally printed mixed-material optical fiber sensor. The transmission spectra in plots 806a-d and 808a-d indicate an increase in transmission upon heating in both types of mixed-material optical fiber sensors, which can be reversible upon cooling. Additionally, at 600 nm, a slight dip in the spectra is observed under UV radiation for both types of mixed-material optical fibers. For the horizontally printed mixed-material optical fiber sensor at 600 nm and without UV exposure, the transmission percentages are 13.01%, 15.55%, and 17.03% at temperatures of 25°C, 35°C, and 45°C, respectively. Under UV exposure, the transmission percentages at 600 nm decrease to 12.65%, 15.17%, and 16.67%. For the vertically printed mixed-material optical fiber sensor, at 600 nm and without UV exposure, the transmission percentages are 9.13%, 14.32%, and 17.42% at 25°C, 35°C, and 45°C, respectively. Under UV exposure, the transmission percentages at 600 nm reduce to 8.57%, 14.07%, and 17.2% respectively.

Therefore, both types of mixed-material optical fiber sensors can be used to measure temperature and UV levels upon calibration. The calibration can be performed to enable detection of the small changes in transmission percentages upon exposure of the mixed-material optical fiber sensors to UV light. The addition of both a UV-sensitive and a temperature-sensitive powder in the resin for the mixed-material optical fiber sensors can have minimal impact on the spectra due to the agglomeration and mixed arrangement of the powders in the fibers.

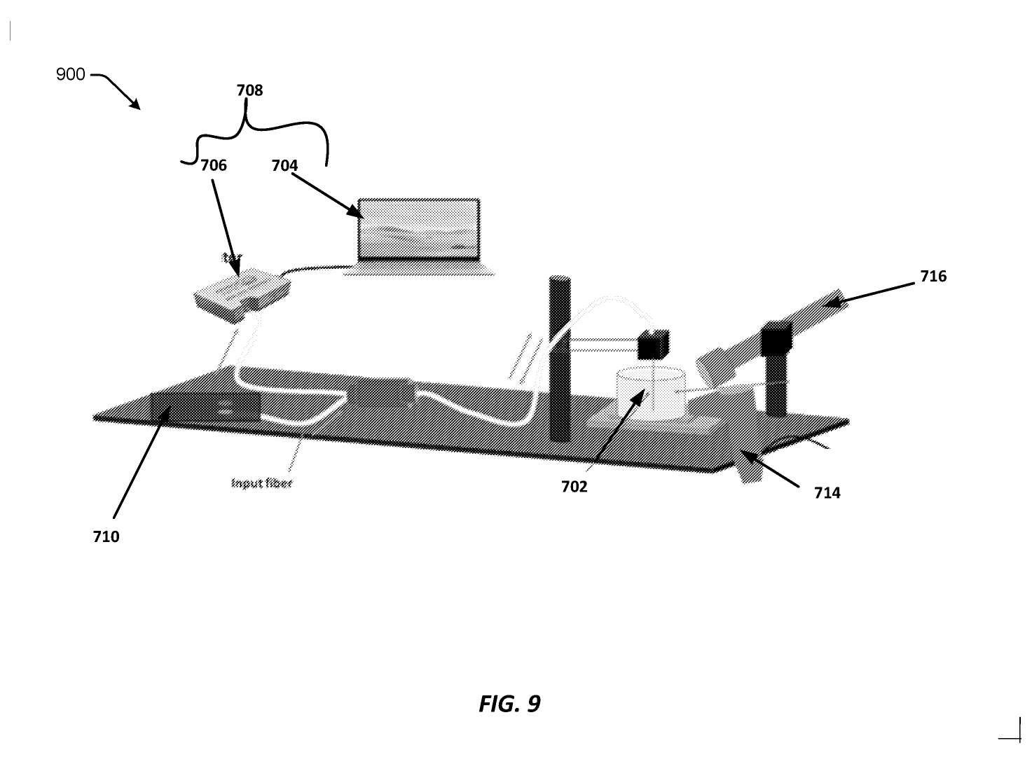

FIG. 9 shows a block diagram of an example of a temperature and ultraviolet (UV) light detection system 900 including an optical fiber sensor 702, according to some embodiments of the present disclosure. In addition to the optical fiber sensor 702, the system 900 can include a data acquisition system 708 electrically coupled with the optical fiber sensor 702. The data acquisition system 708 can include one or more components for receiving an output signal from the optical fiber sensor 702 and processing the output signal, such as a spectrometer 706 and a computing device 704.

In some examples, the system 900 can further include a light source 710 for transmitting a light signal to the optical fiber sensor 702. The optical fiber sensor 702 can be a mixed-material optical fiber sensor or a multi-material optical fiber sensor and can have vertically oriented or horizontally oriented optical fibers. The system 900 can be used to measure reflectivity of the light signal from the optical fiber sensor 702. To do so, a backscattered light signal can be generated from reflection of the light signal traveling through the optical fiber sensor 702. The spectrometer 706 or another suitable device for measuring an intensity of a light signal can then be configured to measure an intensity of the backscattered light signal. To do so, the spectrometer 706 or another suitable device can be positioned to measure the backscattered light signal from a side of the optical fiber sensor 702 at which the optical fiber sensor 702 received the light signal from the light source 710.

In some examples, the system 900 can also include a heating element 714 and a UV light element 716 for applying heat and UV light respectively to an environment associated with the optical fiber sensor 702. In other examples, temperature fluctuations or UV light exposure of the optical fiber sensor 702 can be naturally occurring (e.g., from climate changes, sun exposure, etc.) and therefore the system 900 may not include the heating element 714 and UV light element 716. As a result of temperature fluctuations, UV light exposure, or a combination thereof, one or more optical properties of the optical fiber sensor 702, which can include a thermochromic powder and a photochromic powder, can change. As a result, an intensity of the backscattered light signal reflected by the optical fiber sensor 702 may change (e.g., more or less light may be reflected depending on the new optical properties). Thus, by measuring the intensity of the backscattered light signal from the optical fiber sensor 702, the data acquisition system 708 can determine a temperature, a level of UV light exposure, or a combination thereof of the optical fiber sensor 702 and therefore of the environment associated with the optical fiber sensor 702.

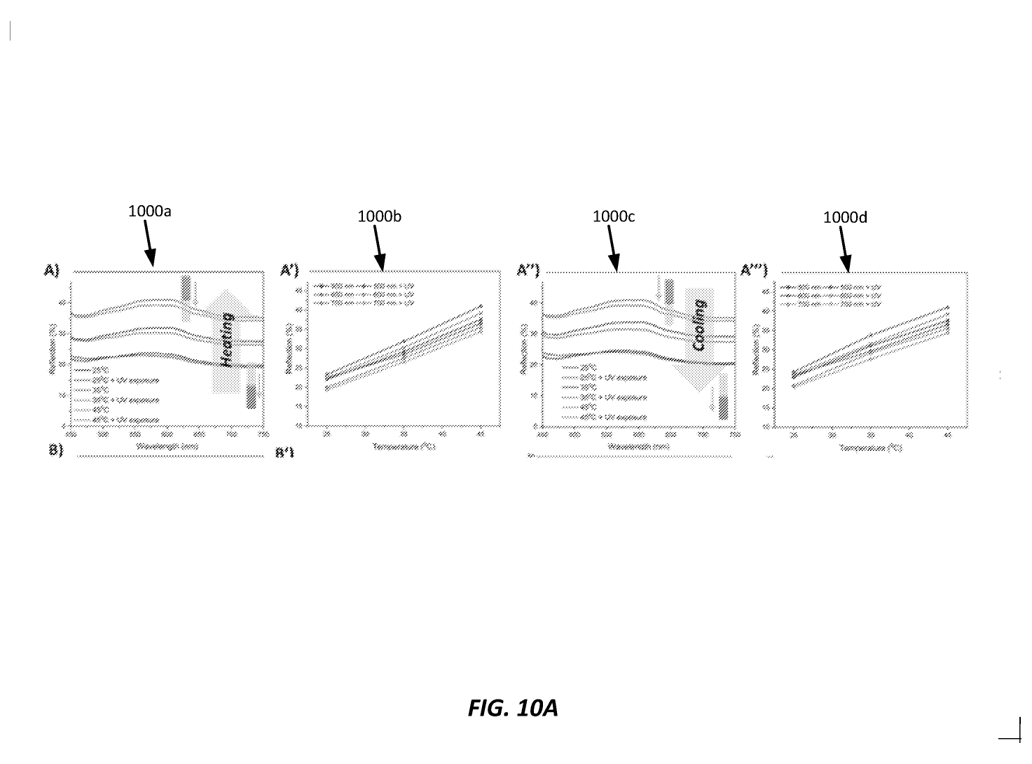

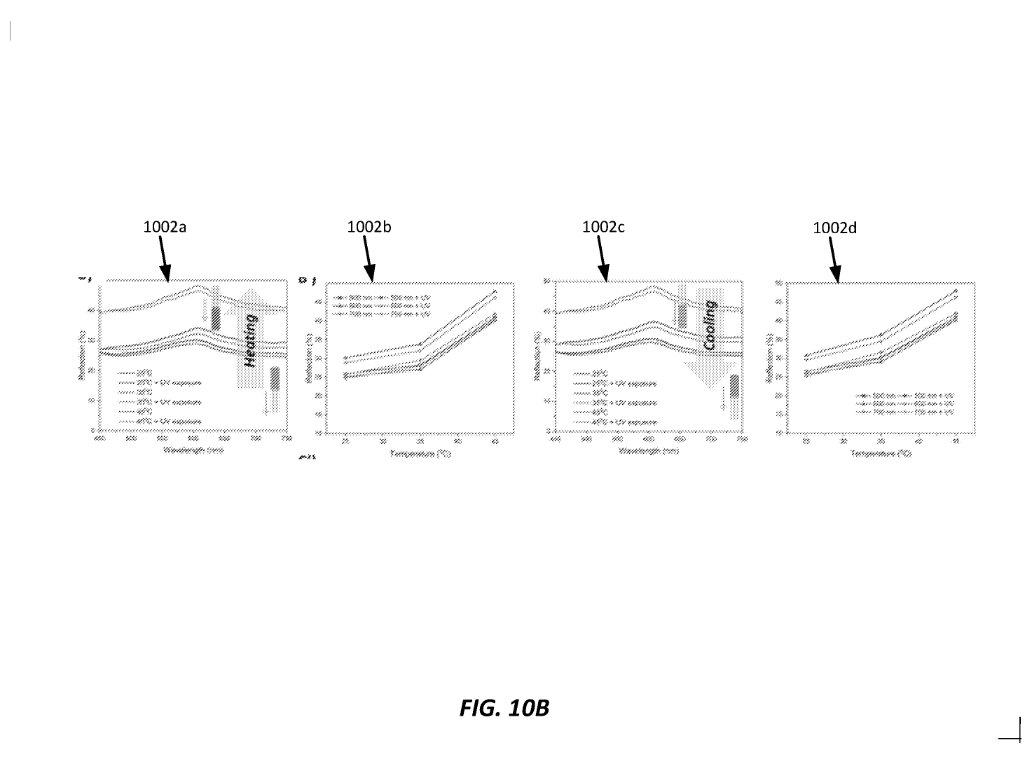

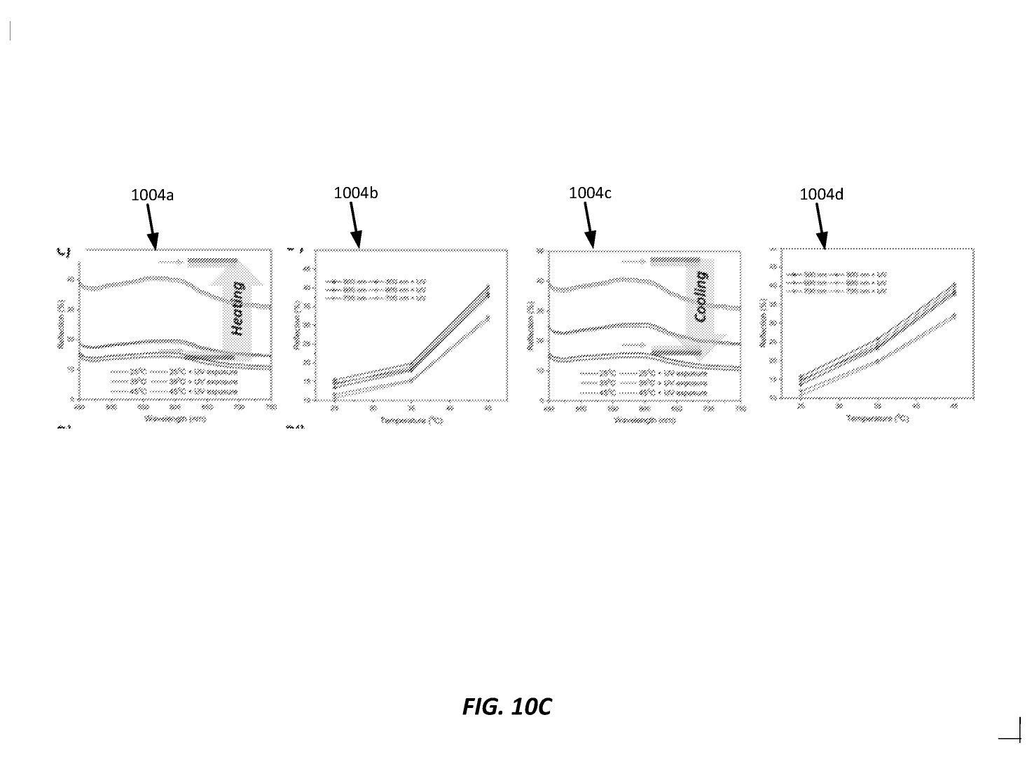

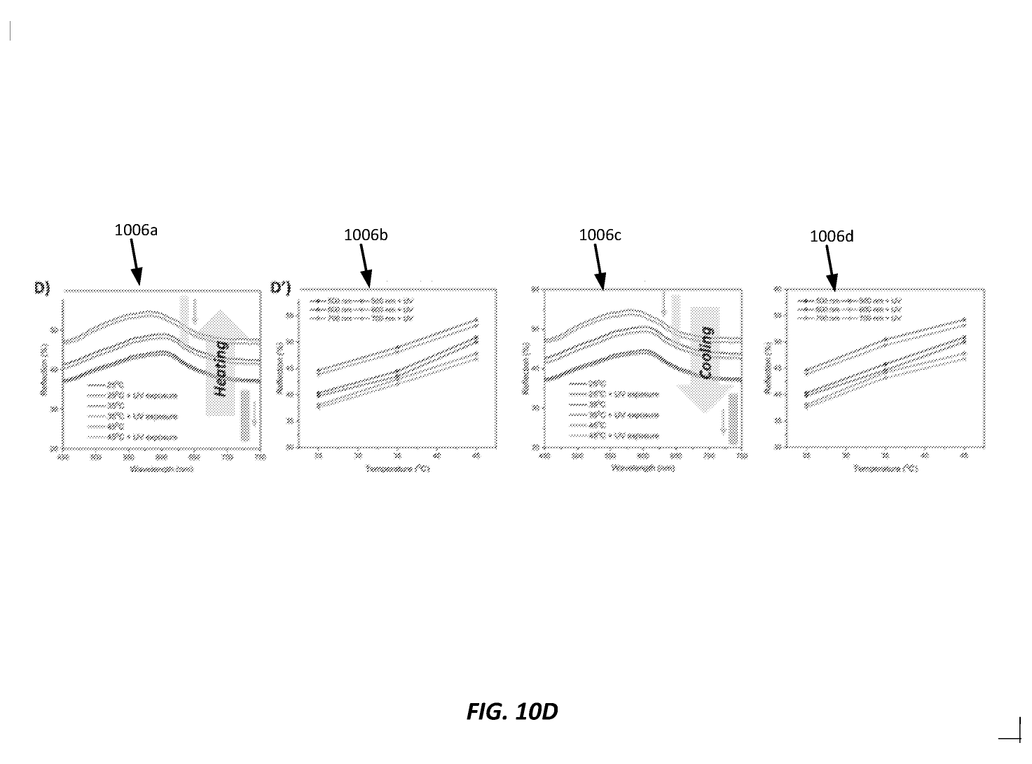

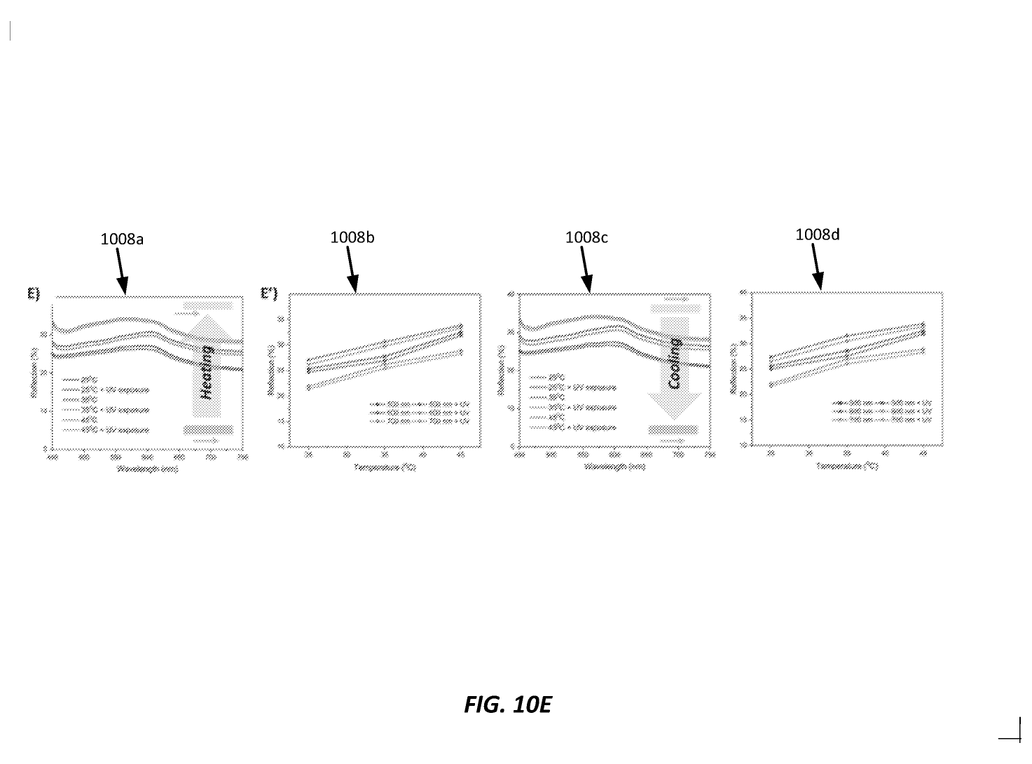

FIG. 10A shows plots 1000a-d of reflection spectra of a vertically printed multi-material optical fiber sensor, according to at least one embodiment of the present disclosure. An example of a vertically printed multi-material optical fiber sensor 400a is depicted in FIGS. 4A, 5A, and 6A. The vertically printed multi-material optical fiber sensor can be positioned in a temperature and ultraviolet (UV) light detection system, such as the temperature and ultraviolet (UV) light detection system 900 depicted in FIG. 9. In a particular example, a UV-sensitive section (e.g., section 402b) of the vertically printed multi-material optical fiber sensor can be positioned close to an incoming light signal (e.g., a light signal from light source 710). The reflection spectra can include reflection spectrums of the vertically printed multi-material optical fiber sensor under various conditions. For example, the plots 1000a-d can show a reflection spectrum of the optical sensor at 25 degrees Celsius without UV exposure, at 25 degrees Celsius with UV exposure, at 35 degrees Celsius without UV exposure, at 35 degrees Celsius with UV exposure, at 45 degrees Celsius without UV exposure, and at 45 degrees Celsius with UV exposure.

As shown in plots 1000a-d, the reflection spectra of the vertically printed multi-material optical fiber sensor increases with rising temperature. Additionally, the reflection spectra of the vertically printed multi-material optical fiber sensor decreases with UV exposure. Upon cooling, the reflection spectra can be restored, with a slight hysteresis. A highest reflection can be observed in the 600 nm range and without UV exposure. For example, as shown in plots 1000a and 1000c, the reflection percentages at 600 nm, without UV exposure, are 23.36%, 31.87%, and 41.01% at temperatures of 25°C, 35°C, and 45°C, respectively. With exposure to UV light, the reflection percentages at 600 nm reduce to 22.5%, 30.3%, and 39.19%, respectively. The variation in reflection percentages with temperature fluctuations and with UV exposure indicate that vertically printed multi-material optical fiber sensors can be used for concurrent UV light and temperature monitoring. In particular, in this example, temperature measurements, a level of UV light, or a combination thereof can be determined based on a reflection percentage of the vertically printed multi-material optical fiber sensor upon receiving a light signal with a wavelength of 600 nm.

FIG. 10B shows plots 1002a-d of reflection spectra of a vertically printed multi-material optical fiber sensor, according to at least one embodiment of the present disclosure. In another particular example, a temperature-sensitive section (e.g., section 402a) of the vertically printed multi-material optical fiber sensor can be positioned close to an incoming light signal (e.g., a light signal from light source 710). Similar to the previous example shown in FIG. 10A, the plots 1002a-d can show a reflection spectrum of the optical sensor at 25 degrees Celsius without UV exposure, at 25 degrees Celsius with UV exposure, at 35 degrees Celsius without UV exposure, at 35 degrees Celsius with UV exposure, at 45 degrees Celsius without UV exposure, and at 45 degrees Celsius with UV exposure.

As shown in the plots 1002a-d, reflection spectra of the vertically printed multi-material optical fiber sensor increases with temperature and decreases with UV exposure. A maximum reflection of the vertically printed multi-material optical fiber sensor was observed at the 600 nm range without UV exposure, with reflection percentages measured at 30.16%, 33.85%, and 47.93% at 25°C, 35°C, and 45°C, respectively. Exposure to UV light reduced the reflection percentages to 28.90%, 32.07%, and 36.21%, respectively. The variation in reflection percentages with temperature fluctuations and with UV exposure further indicate that vertically printed multi-material optical fiber sensors can be used for concurrent UV light and temperature monitoring. In particular, in this example, temperature measurements, a level of UV light, or a combination thereof can be determined based on a reflection percentage of the vertically printed multi-material optical fiber sensor upon receiving a light signal with a wavelength of 600 nm.

FIG. 10C shows plots 1004a-d of reflection spectra of a horizontally printed multi-material fiber, according to at least one embodiment of the present disclosure. An example of a horizontally printed multi-material optical fiber sensor 400b is depicted in FIGS. 4B, 5B, and 6B. The horizontally printed multi-material optical fiber sensor can be positioned in a temperature and ultraviolet (UV) light detection system, such as the temperature and ultraviolet (UV) light detection system 900 depicted in FIG. 9. Due to a UV-sensitive section (e.g., section 404a) and a temperature-sensitive section (e.g., section 404b) of the horizontally printed multi-material optical fiber sensor having horizontally oriented fibers, both sections can be positioned with a portion close to the light source. Similar to the previous examples of FIGS. 10A-10B, plots 1004a-d can show reflection spectrums of the optical fiber sensor at 25 degrees Celsius without UV exposure, at 25 degrees Celsius with UV exposure, at 35 degrees Celsius without UV exposure, at 35 degrees Celsius with UV exposure, at 45 degrees Celsius without UV exposure, and at 45 degrees Celsius with UV exposure.

Further similar to the plots in FIGS. 10A and 10B, plots 1004a-d of FIG. 10C show that peak reflection occurs at 600 nm. Additionally, plots 1004a-d show that the horizontally printed multi-material fiber is sensitive to both temperature and UV exposure. Without UV exposure, the reflection percentages of the horizontally printed multi-material fiber at 600 nm are 15.44%, 19.81%, and 40.36% at temperatures of 25°C, 35°C, and 45°C, respectively. Exposure to UV light decreases the reflection percentages to 14.22%, 18.98%, and 39.51%, respectively. The variation in reflection percentages with temperature fluctuations and with UV exposure indicate that horizontally printed multi-material optical fiber sensors can be used for concurrent UV light and temperature monitoring.

FIGS. 10D shows plots 1006a-d of reflection spectra of a horizontally printed mixed-material optical fiber sensor, while FIG. 10E shows plots 1008a-d of reflection spectra of a vertically printed mixed-material optical fiber sensor. An example of a mixed-material optical fiber sensor 400c is depicted in FIG. 4C, FIG. 5C, and FIG. 6C. The horizontally printed and the vertically printed mixed-material optical fiber sensor can be positioned in a temperature and ultraviolet (UV) light detection system, such as the temperature and ultraviolet (UV) light detection system 900 depicted in FIG. 9.

As shown by plots 1008a-d in comparison with plots 1006a-d, the horizontally printed mixed-material optical fiber sensor can exhibit lower reflection compared to the vertically printed mixed-material optical fiber sensor. This can be due to the orientation of the optical fibers in the different types of mixed-material optical fiber sensors. The reflection spectra reveal a positive change with increasing temperature in both types of mixed-material optical fiber sensors, which can be reversible during a cooling phase. Additionally, as shown in plots 1008a-d and 1006a-d, in both types of mixed-material optical fiber sensors, a dip in the reflection spectra is observed under UV radiation. For the vertically printed mixed-material optical fiber sensor, at 600 nm and without UV light exposure, the reflection percentages are shown as being 44.64%, 48.99%, and 54.21% at temperatures of 25°C, 35°C, and 45°C, respectively. Under UV exposure, the reflection percentages decrease to 43.86%, 48.08%, and 53.12%. In the horizontally printed mixed-material optical fiber sensor, at 600 nm and without UV light exposure, the reflection percentages are shown at 27.1%, 30.61%, and 33.87% at temperatures of 25°C, 35°C, and 45°C, respectively. Under UV exposure, the reflection percentages decreased to 26.18%, 29.79%, and 33.31%, respectively. The variation in reflection percentages with temperature fluctuations and with UV exposure indicate that both types of mixed-material optical fiber sensors can be used for concurrent UV light and temperature monitoring.

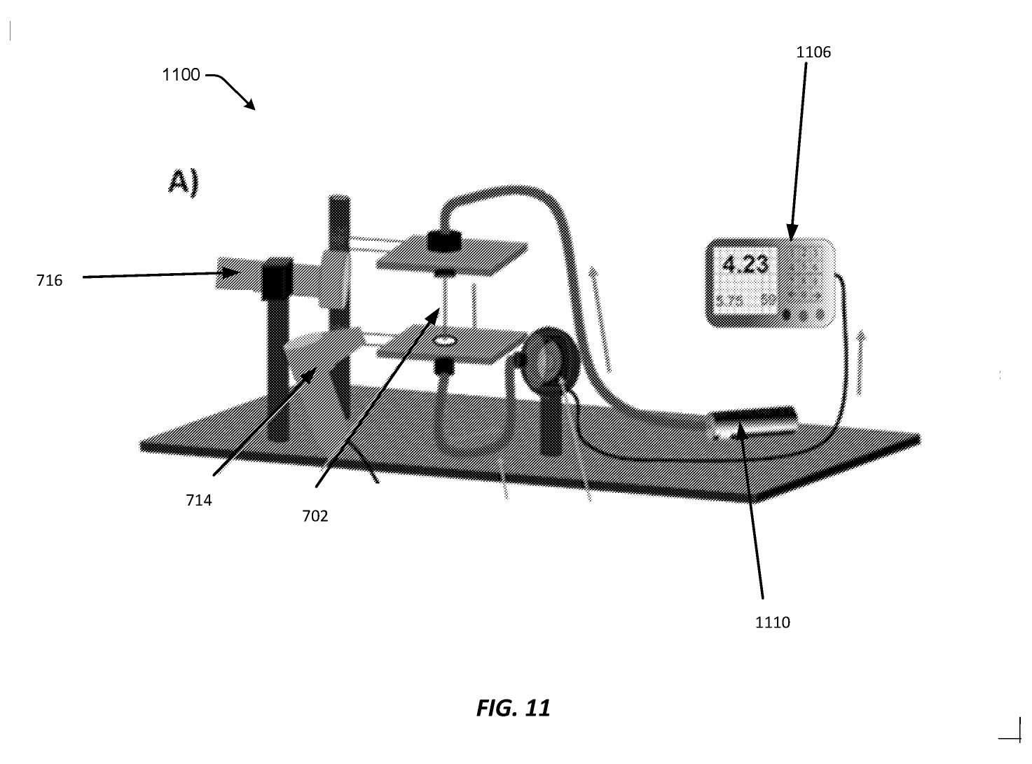

FIG. 11 shows a block diagram of an example of a temperature and ultraviolet (UV) light detection system 1100 including an optical fiber sensor 702, according to some embodiments of the present disclosure. In addition to the optical fiber sensor 702, the system 1100 can include a data acquisition system electrically coupled with the optical fiber sensor 702. The data acquisition system can include one or more components for receiving an output signal from the optical fiber sensor 702 and processing the output signal. For example, the data acquisition system can include a power meter 1106 or other suitable device for measuring power of a light signal transmitted through the optical fiber sensor 702. The data acquisition system may further include a computing device (not shown) or other suitable device for determining a level of UV light, a temperature, or a combination thereof based on the power measurement.

In some examples, the system 1100 can further include a light source 1110 for transmitting a light signal to the optical fiber sensor 702. The light source 1110 can include a laser for emitting light of at one or more wavelengths (e.g., a wavelength around 620 nm) or another suitable device for emitting a light signal. The optical fiber sensor 702 can be a mixed-material optical fiber sensor or a multi-material optical fiber sensor and can have vertically oriented or horizontally oriented optical fibers. To measure the power of the light signal transmitted through the optical fiber sensor 702, the power meter 1106 may be positioned near an opposite side of the optical fiber sensor 702 from a side at which the light signal is received from the light source 1110.

In some examples, the system 700 can also include a heating element 714 and a UV light element 716 for applying heat and UV light respectively to an environment associated with the optical fiber sensor 702. In other examples, temperature fluctuations or UV light exposure of the optical fiber sensor 702 can be naturally occurring (e.g., from climate changes, sun exposure, etc.) and therefore the system 700 may not include the heating element 714 and UV light element 716.

As a result of temperature fluctuations, UV light exposure, or a combination thereof, one or more optical properties of the optical fiber sensor 702, which can include a thermochromic powder and a photochromic powder, can change. The change in optical properties can change the power of the light signal transmitted through the optical fiber sensor 702 (e.g., a decrease in power of the light signal traveling through the optical sensor can change depending on the new optical properties). Thus, by measuring the power of the light signal transmitted through the optical fiber sensor 702, the data acquisition system can determine a temperature, a level of UV light exposure, or a combination thereof of the optical fiber sensor 702 and therefore of the environment associated with the optical fiber sensor 702.

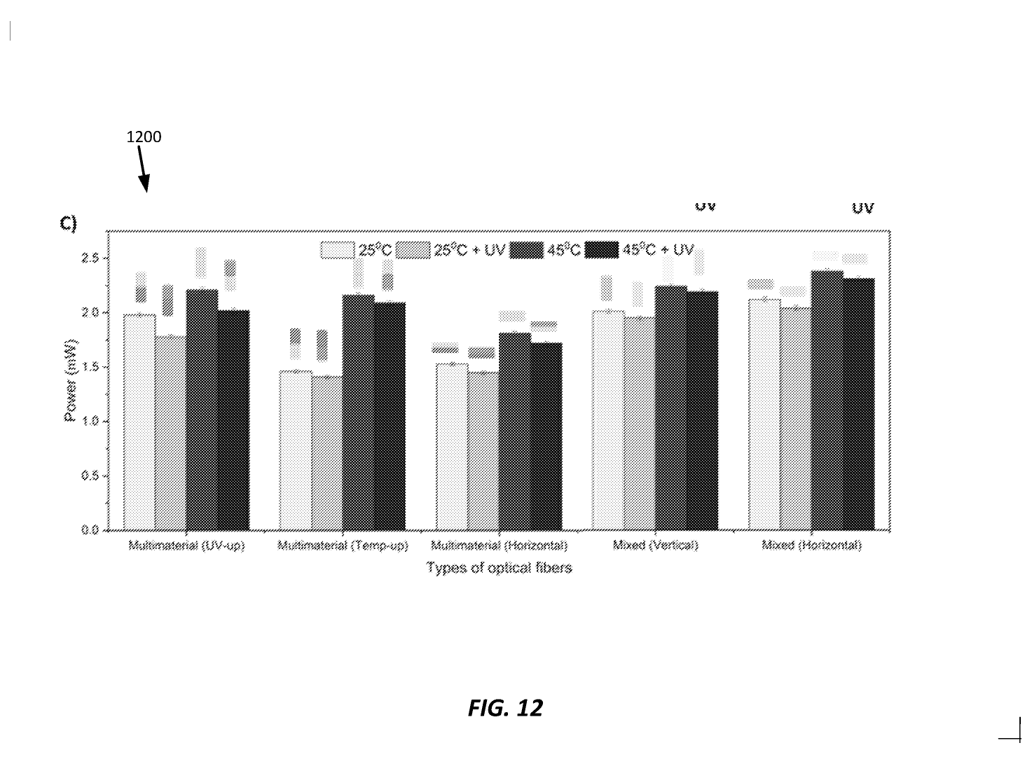

FIG. 12 shows a plot 1200 of power transmitted through different types of optical fiber sensors and under different conditions. For example, the plot 1200 can show power transmitted through a vertically printed multi-material optical fiber sensor positioned with a temperature-sensitive section near a light source (e.g., light source 1110) and a UV-sensitive section near a power meter (e.g., power meter 1106). This configuration can be referred to in FIG. 12 as multi-material UV-up. The plot 1200 can further show power transmitted through a vertically printed multi-material optical fiber sensor positioned with a temperature-sensitive section near the power meter and a UV-sensitive section near the light source (multi-material temp-up). Additionally, the plot 1200 shows power transmitted through a horizontally printed multi-material optical fiber sensor (multi-material horizontal), horizontally printed mixed-material optical fiber sensor (mixed horizontal), and a vertically printed mixed material optical fiber sensor (mixed vertical).

For each type of optical fiber sensor, there can be an increase in power transmitted when a temperature increased from 25 degrees Celsius to 45 degrees Celsius. The increase in power can be due to a change in optical properties (e.g., a loss of color) of the optical fiber sensors upon heating. The change in optical properties can occur due to a thermochromic powder used in each of the optical fiber sensors. Additionally, there can be a decrease in power transmitted when each of the optical fiber sensors are exposed to UV light. The decrease in power can be due to an additional change in optical properties (e.g., a transparent-to-blue color change) of the optical fiber sensors upon UV light exposure. The additional change in optical properties can occur due to a photochromic powder used in each of the optical fiber sensors.

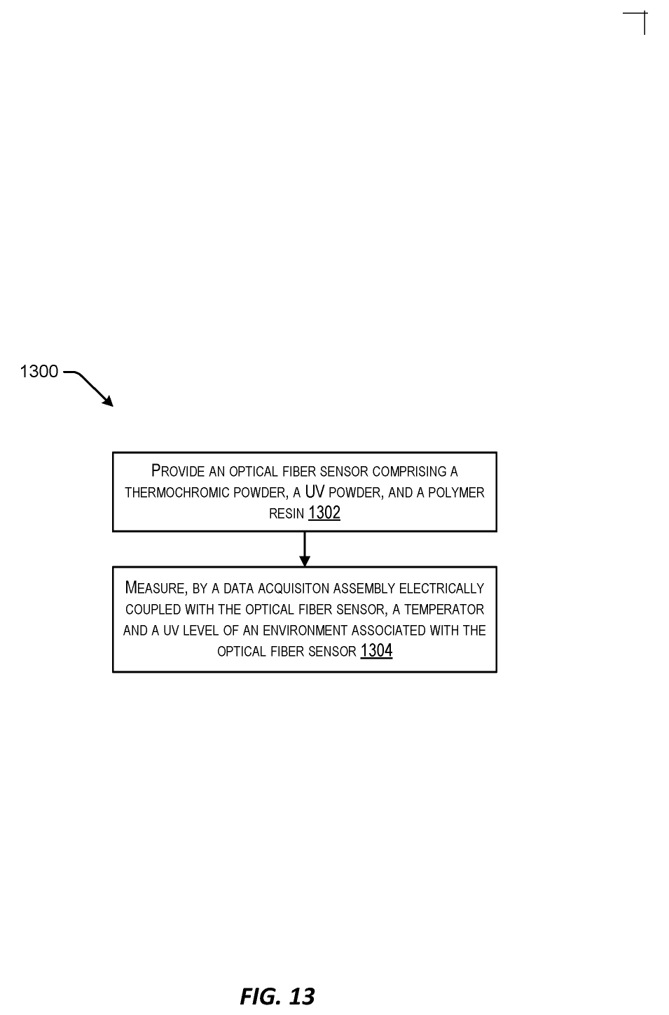

FIG. 13 shows a flowchart of an example of a method 1300 for monitoring temperature and UV light using an optical fiber sensor, according to some embodiments of the present disclosure. In other examples, the method 100 can include more steps, fewer steps, different steps, or a different order of the steps depicted in FIG. 1.

At block 1302, the method 1300 can involve providing an optical fiber sensor comprising a thermochromic powder, a UV-sensitive powder, and a polymer resin. In some examples, the optical fiber sensor can be a mixed-material optical fiber sensor. The mixed-material optical fiber sensor can be 3D printed using a dual-sensitive resin, which can comprise the UV-sensitive powder, the thermochromic powder, and the polymer resin. The mixed-material optical fiber can be 3D printed in a vertical orientation and, as a result, have vertically oriented optical fibers. The vertically oriented optical fibers can be substantially parallel to plane A depicted in FIG. 4A. Otherwise, the mixed-material optical fiber can be 3D printed in a horizontal orientation and, as a result, have horizontally oriented optical fibers. The horizontally oriented optical fibers can be substantially perpendicular to plane A depicted in FIG. 4A.

In other examples, the optical fiber sensor can be a multi-material optical fiber sensor. The multi-material optical fiber sensor can have at least a first section with a temperature-sensitive resin and a second section with a UV-sensitive resin. The UV-sensitive resin can comprise the UV-sensitive powder and the polymer resin while the temperature-sensitive resin can comprise the thermochromic power and the polymer resin. If the multi-material optical fiber sensor is printed vertically, each of the sections can be orientated substantially parallel to a cross section of the multi-material optical fiber sensor. The cross section can be along plane A depicted in FIG. 4A. In other words, for a vertically printed multi-material optical fiber sensor, the sections can span across the cross section and can span along a portion of a length of the multi-material optical fiber sensor. Otherwise, if the multi-material optical fiber sensor is printed horizontally, each of the sections can be orientated substantially perpendicular to the cross section of the multi-material optical fiber senso along plane A. In other words, for a horizontally printed multi-material optical fiber sensor, the sections can span across a portion of the cross section and can span along a length of the multi-material optical fiber sensor.

At block 1304, the method 1300 can involve measuring, by a data acquisition system electrically coupled with the optical fiber sensor, a temperature and a level of UV light of an environment associated with the optical fiber sensor. To do so, the data acquisition system may detect an output signal from the optical fiber sensor. The output signal can correspond to an intensity, transmission percentage, a power, or another suitable measurement of a light signal transmitted through the optical fiber sensor. Additionally or alternatively, the output signal can correspond to an intensity, reflection percentage, a power, or another suitable measurement of a light signal reflected by the optical fiber sensor. Due to the optical fiber sensor comprising the thermochromic powder and the UV-sensitive powder, the optical fiber sensor can be thermochromic and photochromic. Thus, optical properties of the optical fiber sensor can depend on a temperature and a level of UV light to which the optical fiber sensor is exposed in the environment. The optical properties of the optical fiber sensor can affect the output signal detected by the data acquisition system. Thus, the data acquisition system can determine a temperature, a level of UV light, or a combination thereof based on the output signal.

What is claimed is:

1. A system for temperature and ultraviolet (UV) light detection, the system comprising:
an optical fiber sensor comprising:
a temperature-sensitive resin comprising a thermochromic powder and a polymer resin; and
a UV-sensitive resin comprising a UV-sensitive powder and the polymer resin; and
a data acquisition system electrically coupled to the optical fiber sensor, the data acquisition system being configured to detect an output signal from the optical fiber sensor, the output signal corresponding to an intensity of a light signal transmitted through the optical fiber sensor.

2. The system of claim 1, wherein the data acquisition system is further configured to determine a level of UV light and a temperature measurement based on the output signal.

3. The system of claim 1, wherein the data acquisition system is further configured to detect a second output signal from the optical fiber sensor, the second output signal corresponding to an intensity of a backscattered light signal, the backscattered light signal being generated from the light signal transmitted through the optical fiber sensor.

4. The system of claim 3, wherein the data acquisition system is configured to determine a level of UV light and a temperature measurement based on the second output signal.

5. The system of claim 1, wherein the optical fiber sensor comprises a first section with the temperature-sensitive resin and a second section with the UV-sensitive resin, wherein the first section and the second section are oriented substantially perpendicular to a cross section of the optical fiber sensor.

6. The system of claim 1, wherein the optical fiber sensor comprises a first section with the temperature-sensitive resin and a second section with the UV-sensitive resin, wherein the first section and the second section are oriented substantially parallel to a cross section of the optical fiber sensor.

7. The system of claim 1, wherein the temperature-sensitive resin is thermochromic and wherein the UV-sensitive resin is photochromic.

8. The system of claim 1, further comprising a light source configured to transmit the light signal to the optical fiber sensor, and wherein the data acquisition system comprises a spectrometer configured to measure the intensity of the light signal.

9. A method comprising:
providing an optical fiber sensor comprising a thermochromic powder, a UV-sensitive powder, and a polymer resin; and
measuring, by a data acquisition system electrically coupled with the optical fiber sensor, a temperature and a level of UV light of an environment associated with the optical fiber sensor.

10. The method of claim 9, wherein measuring the temperature and the level of UV light of the environment comprises:
detecting, by the data acquisition system electrically coupled to the optical fiber sensor, an output signal from the optical fiber sensor, the output signal corresponding to an intensity of a light signal transmitted through the optical fiber sensor; and
determining the temperature and the level of UV light based on the output signal.

11. The method of claim 10, wherein measuring the temperature and the level of UV light of the environment comprises:
detecting, by the data acquisition system electrically coupled to the optical fiber sensor, an output signal from the optical fiber sensor, the output signal corresponding to an intensity of a backscattered light signal, the backscattered light signal being generated from a light signal transmitted through the optical fiber sensor; and
determining the temperature and the level of UV light based on the output signal.

12. The method of claim 10, wherein the optical fiber sensor comprises a temperature-sensitive resin, the temperature-sensitive resin comprising the thermochromic powder and the polymer resin, and wherein the optical fiber sensor comprises a UV-sensitive resin, the UV-sensitive resin comprising the UV-sensitive powder and the polymer resin.

13. The method of claim 13, wherein the optical fiber sensor comprises a first section with the temperature-sensitive resin and a second section with the UV-sensitive resin, wherein the first section and the second section are oriented substantially perpendicular to a cross section of the optical fiber sensor.

14. The method of claim 13, wherein the optical fiber sensor comprises a first section with the temperature-sensitive resin and a second section with the UV-sensitive resin, wherein the first section and the second section are oriented substantially parallel to a cross section of the optical fiber sensor.

15. The method of claim 10, wherein the optical fiber sensor comprises a dual-sensitive resin that comprises the UV-sensitive powder, the thermochromic powder, and the polymer resin.

16. The method of claim 10, wherein providing the optical fiber sensor comprising the thermochromic powder, the UV-sensitive powder, and the polymer resin comprises producing the optical fiber sensor using digital light processing 3D printing.

17. An optical fiber sensor comprising:
a temperature-sensitive resin comprising a thermochromic powder and a polymer resin; and
a UV-sensitive resin comprising a UV-sensitive powder and the polymer resin.

18. The optical fiber sensor of claim 17, comprising a first section with the temperature-sensitive resin and a second section with the UV-sensitive resin, wherein the first section and the second section are oriented substantially perpendicular to a cross section of the optical fiber sensor.

19. The optical fiber sensor of claim 17, comprising a first section with the temperature-sensitive resin and a second section with the UV-sensitive resin, wherein the first section and the second section are oriented substantially parallel to a cross section of the optical fiber sensor.

20. The optical fiber sensor of claim 17, wherein the temperature-sensitive resin is thermochromic and wherein the UV-sensitive resin is photochromic.
